(19) United States
(12) Patent Application Publication
(10) Pub. No.: US 2026/0231047 A1
(43) Pub. Date: Aug. 6, 2026

(54) METHOD FOR POWER SHARING FOR UPLINK MULTI-PANEL TRANSMISSION

(71) Applicant: Google LLC, Mountain View, CA (US)

(72) Inventors: Yushu ZHANG, Beijing (CN); Jia-Hong LIOU, Taipei City, Taiwan (CN)

(21) Appl. No.: 19/151,956

(22) PCT Filed: Feb. 17, 2023
(86) PCT No.: PCT/CN2023/076935

§ 371 Date: Jul. 29, 2025

(51) Int. Cl. H04W 52/14; H04W 52/36

(52) U.S. Cl. CPC H04W 52/146; H04W 52/365; H04W 52/367

(57) ABSTRACT

Wireless communication devices and methods, including computer programs encoded on storage media, implement power sharing modes for uplink transmissions (and managing power levels thereof) from multiple antenna panels of a user equipment, UE.A network entity configures the UE to transmit uplink communications from multiple antenna panels with respective transmission power levels determined according to a semi-static power sharing mode, a dynamic power sharing mode or a fixed power sharing mode. In some cases, the UE provides a power headroom, PH, report regarding the determined transmission power levels. Uplink communications are transmitted using power levels determined by the UE that splits the available power across the multiple panels to fit within the available power budget.

### FIELD

The present disclosure relates generally to wireless communications, and more particularly, to transmission power control.

### BACKGROUND

The Third Generation Partnership Project (3GPP) specifies a radio interface referred to as fifth generation (5G) new radio (NR) (5G NR). An architecture for a 5G NR wireless communication system includes a 5G core (5GC) network, a 5G radio access network (5G-RAN), a user equipment (UE), etc. The 5G NR architecture seeks to provide increased data rates, decreased latency, and/or increased capacity compared to prior generation cellular communication systems.

A base station (BS, such as a gNB) may configure a UE to transmit an uplink signal, e.g., sounding reference signal (SRS), physical uplink control channel (PUCCH), or physical uplink shared channel (PUSCH) based on one spatial domain filter, e.g., one beam, from one UE panel. The network entity may provide beam indication, e.g., transmission configuration indication (TCI) indication or spatial relation information indication, for an uplink signal by RRC signaling, media access control (MAC) control element (CE) or downlink control information (DCI). The UE may derive the uplink beam and the uplink power control parameters, e.g., P0, alpha, pathloss reference signal and closed-loop power control index, based on the indicated TCI or spatial relation information. TCI for transmitting an uplink signal may be Joint TCI or uplink (UL) TCI.

The current technical specifications provide the uplink power control for PUSCH, PUCCH and SRS, power headroom report (PHR) and power sharing for carrier aggregation and dual connectivity (e.g., 3GPP TS 38.213 section 7), TCI indication procedure (e.g., 3GPP TS 38.214 section 5.1.5), and the TCI switching delay for known and unknown TCI state (e.g., 3GPP TS 38.133 section 10.2). The current technical specifications do not specify, in all scenarios, how to control or share transmission powers when a UE uses multiple antenna panels for uplink transmissions (multi-panel transmissions).

### SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

The present disclosure provides methods, systems, and techniques for uplink transmissions (and managing power levels thereof) from multiple antenna panels (“multi-panel”) of a user equipment (UE). For example, when a network entity (e.g., a base station, BS) schedules the UE to transmit uplink communications from multiple antenna panels, the transmission power levels for each of the multiple antenna panels may not be specified or that the UE may determine the power levels to improve signal strength or avoid conflicting power levels (e.g., to avoid a sum of power levels of the multiple antenna panels exceeding a total maximum power level). In some cases, the UE provides a power headroom, PH, report regarding the determined power levels across the multiple antenna panels.

A BS configures a UE to transmit uplink communications (such as, sounding reference signals, SRS, data transmitted a physical uplink control channel, PUCCH, and/or a physical uplink shared channel, PUSCH) based on one spatial domain filter, e.g., for each beam and/or from each antenna panel (e.g., an antenna panel may generate multiple beams at various times). The BS may provide beam indication (e.g., transmission configuration indication, TCI) or spatial relation information indication, for the uplink signal, using radio resource control (RRC) signaling, medium access control (MAC) control element (CE), or downlink control information (DCI). The UE may then derive the uplink beam and the uplink power control parameters (e.g., P0, alpha, pathloss reference signal and closed-loop power control index) based on the beam indication or the spatial relation information. The beam indication may be a joint TCI or an uplink (UL) TCI.

When the BS configures a UE to transmit multiple communications using multiple available antenna panels, the BS may send a single DCI or multiple DCIs for indicating the respective TCI for each of the multiple antenna panels. When multiple DCIs are used, the UE may or may not be able to change the uplink transmission power levels in the multiple antenna panels, depending on the time gap and TCI switching delay for known and unknown TCI states. In some cases, the uplink transmission power control involves power level determination and power sharing across the multiple antenna panels for carrier aggregation and dual connectivity.

The present disclosure provides methods and techniques for the UE to manage or determine the power levels and power sharing of multiple antenna panels such that some uplink communications may utilize maximum power levels available or allowable for the UE and the UE properly splits the power level across the multiple panels to fit within the available power budget. Conventionally, UE's uplink power is limited only by the maximum transmission power for UE's power class (e.g., 23 dBm for power class 3, or 26 dBm for power class 2). In case of multi-panel simultaneous uplink transmissions, the telecommunication industry has yet to establish methods and limits for individual panel power determination.

In addition, for multi-DCI based multi-panel transmission, the BS may transmit two DCIs with different timelines. That is, a BS may transmit a first DCI scheduling a first uplink transmission earlier than a second DCI scheduling a second uplink transmission. The UE may then transmit the first uplink transmission earlier than the second uplink transmission. When determining the transmission power for the first uplink transmission after receiving the first DCI, the UE has not (and may not) completely detected or decoded the second DCI, causing problems for determining or adjusting the power levels and power sharing across multiple antenna panels. The present disclosure provides methods and techniques for determining the transmission power levels with preview capability so that the UE may determine the transmission power levels in view of the second uplink transmission.

In an illustrative aspect, the BS and the UE may use three different modes to determine the uplink transmission power levels for panels transmitting overlapping uplink communications. For example, in a semi-static power sharing mode, the BS may configure the UE with a maximum power level per panel and provide the UE with a power sharing scheme (e.g., capable UEs transmit at the configured power levels accordingly). In a dynamic power sharing mode, the UE may dynamically decide respective maximum power levels for each of the multiple antenna panels. In a fixed power sharing mode, the BS may provide a set of parameters to the UE so that the UE decides the respective power levels (while the specific power levels may vary from UE to UE).

As such, the present disclosure provides various implementations for power sharing in overlapping uplink multi-panel transmission. That is, the UE may transmit the uplink communications from multiple-panels with the same or different transmission power levels specific to each antenna panel. Because the multi-panel transmission supports UE determined power sharing, the UE may achieve a higher throughput using multi-panel transmission than the conventional global power control when using plural panels. Furthermore, the UE may transmit the same uplink signal from multiple panels using different beams, which increase the reliability for the uplink signal.

Aspects of this disclosure include a wireless communication method by a UE. The example method includes obtaining, from a network entity, a panel-power-sharing configuration that schedules uplink transmissions associated with transmission configuration indication, TCI, states using antenna panels of the UE; determining, based on a power sharing mode indicated in the panel-power-sharing configuration, respective transmission power levels of the antenna panels of the UE; and transmitting the uplink transmissions from the antenna panels using the respective transmission power levels

Aspects of this disclosure include a wireless communication method by a network entity. The example method includes providing, to a UE, a panel-power-sharing configuration that schedules uplink transmissions associated with transmission configuration indication, TCI, states using antenna panels of the UE; and receiving the uplink transmissions from the antenna panels using respective transmission power levels determined based on a power sharing mode indicated in the panel-power-sharing configuration.

Detailed examples of various specific aspects are provided below.

### BRIEF DESCRIPTION OF THE DRAWINGS

FIG. 1 illustrates a diagram of a wireless communications system that includes a plurality of user equipments (UEs) and network entities in communication over one or more cells.

FIG. 2 illustrates an example of a single-downlink control information (DCI) based multi-panel uplink transmissions, in accordance with aspects of this disclosure.

FIG. 3 illustrates an example of a multi-DCI based multi-panel uplink transmissions, in accordance with aspects of this disclosure.

FIG. 4 illustrates an example of a transmission power selection for a first uplink transmission per a first DCI with regard to unknown future scheduling of a second uplink transmission per a second DCI, in accordance with aspects of this disclosure.

FIG. 5 illustrates an example signaling diagram between a user equipment (UE) and a network entity for semi-static power sharing across panels, in accordance with aspects of this disclosure.

FIG. 6 illustrates an example signaling diagram between a UE and a network entity for semi-static power sharing across panels, in accordance with aspects of this disclosure.

FIG. 7 is a flowchart of a method of wireless communications by a UE for semi-static power sharing across panels, in accordance with aspects of this disclosure.

FIG. 8 is a flowchart of a method of wireless communications by a network entity for semi-static power sharing across panels, in accordance with aspects of this disclosure.

FIG. 9 illustrates an example of semi-static power sharing across panels, in accordance with aspects of this disclosure.

FIG. 10 illustrates an example signaling diagram between a UE and a network entity for dynamic-power sharing across panels, in accordance with aspects of this disclosure.

FIG. 11 illustrates an example signaling diagram between a UE and a network entity for dynamic-power sharing across panels, in accordance with aspects of this disclosure.

FIG. 12 is a flowchart of a method of wireless communications by a UE for dynamic-power sharing across panels, in accordance with aspects of this disclosure.

FIG. 13 is a flowchart of a method of wireless communications by a network entity for dynamic-power sharing across panels, in accordance with aspects of this disclosure.

FIG. 14A illustrates an example of per-symbol power scaling for uplink transmissions from one panel with lower priority, in accordance with aspects of this disclosure.

FIG. 14B illustrates an example of per-symbol power scaling for uplink transmissions from all panels with lower priority, in accordance with aspects of this disclosure.

FIG. 15 illustrates an example of per-transmission-occasion power scaling for uplink transmissions from one panel with lower priority, in accordance with aspects of this disclosure.

FIG. 16 illustrates an example of per-transmission-occasion power scaling for uplink transmissions from all panels, in accordance with aspects of this disclosure.

FIG. 17 illustrates an example of per-transmission-occasion power scaling when the timeline requirement is met, in accordance with aspects of this disclosure.

FIG. 18 illustrates an example of the per-symbol transmission power scaling for the first uplink transmission and per-transmission-occasion power scaling for the second uplink transmission when the timeline requirement is met for the first uplink transmission but not met for the second uplink transmission, in accordance with aspects of this disclosure.

FIG. 19 illustrates an example of power headroom report (PHR) calculation based on the first symbol of one transmission occasion, in accordance with aspects of this disclosure.

FIG. 20 illustrates an example of PHR calculation based on the whole transmission occasion with single PHR report, in accordance with aspects of this disclosure.

FIG. 21 illustrates an example of PHR calculation based on the whole transmission occasion with multiple PHRs report, in accordance with aspects of this disclosure.

FIG. 22 illustrates an example signaling diagram between a UE and a network entity for per UE power control with power split per panel, in accordance with aspects of this disclosure.

FIG. 23 illustrates an example signaling diagram between a UE and a network entity for per UE power control with power split per panel, in accordance with aspects of this disclosure.

FIG. 24 is a flowchart of a method of wireless communications by a UE for per UE power control with power split per panel, in accordance with aspects of this disclosure.

FIG. 25 is a flowchart of a method of wireless communications by a network entity for per UE power control with power split per panel, in accordance with aspects of this disclosure.

FIG. 26 is a flowchart of a method of wireless communications by a UE for the transmission power determination with power split per panel, in accordance with aspects of this disclosure.

FIG. 27 is a flowchart of a method of wireless communication at a UE, in accordance with aspects of this disclosure.

FIG. 28 is a flowchart of a method of wireless communication at a network entity, in accordance with aspects of this disclosure.

FIG. 29 is a diagram illustrating a hardware implementation for an example UE apparatus, in accordance with aspects of this disclosure.

FIG. 30 is a diagram illustrating a hardware implementation for one or more example network entities, in accordance with aspects of this disclosure.

Like numerals indicate like elements.

### DETAILED DESCRIPTION

The present disclosure provides methods, systems, and techniques for uplink transmissions (and managing power levels thereof) from multiple antenna panels (“multi-panel”) of a user equipment (UE). For example, when a network entity (e.g., a base station, BS) schedules the UE to transmit uplink communications from multiple antenna panels, the transmission power levels for each of the multiple antenna panels may not be specified or that the UE may determine the power levels to improve signal strength or avoid conflicting power levels (e.g., to avoid a sum of power levels of the multiple antenna panels exceeding a total maximum power level). In some cases, the UE provides a power headroom, PH, report regarding the determined power levels across the multiple antenna panels.

A BS configures a UE to transmit uplink communications (such as, sounding reference signals, SRS, data transmitted a physical uplink control channel, PUCCH, and/or a physical uplink shared channel, PUSCH) based on one spatial domain filter, e.g., for each beam and/or from each antenna panel (e.g., an antenna panel may generate multiple beams at various times). An antenna panel indicates a set of antenna ports. Different antenna panels comprise different, distinct antenna ports. The BS may provide beam indication (e.g., transmission configuration indication, TCI) or spatial relation information indication, for the uplink signal, using radio resource control (RRC) signaling, medium access control (MAC) control element (CE), or downlink control information (DCI). The UE may then derive the uplink beam and the uplink power control parameters (e.g., P0, alpha, pathloss reference signal and closed-loop power control index) based on the beam indication or the spatial relation information. The beam indication may be a joint TCI or an uplink (UL) TCI.

When the BS configures a UE to transmit multiple communications using multiple available antenna panels, the BS may send a single DCI or multiple DCIs for indicating the respective TCI for each of the multiple antenna panels. When multiple DCIs are used, the UE may or may not be able to change the uplink transmission power levels in the multiple antenna panels, depending on the time gap and TCI switching delay for known and unknown TCI states. In some cases, the uplink transmission power control involves power level determination and power sharing across the multiple antenna panels for carrier aggregation and dual connectivity.

The present disclosure provides methods and techniques for the UE to manage or determine the power levels and power sharing of multiple antenna panels such that some uplink communications may utilize maximum power levels available or allowable for the UE and the UE properly splits the power level across the multiple panels to fit within the available power budget. Conventionally, UE's uplink power is limited only by the maximum transmission power for UE's power class (e.g., 23 dBm for power class 3, or 26 dBm for power class 2). In case of multi-panel simultaneous uplink transmissions, the telecommunication industry has yet to establish methods and limits for individual panel power determination.

Aspects of this disclosure overcome such issues (and provide advantages) by controlling and/or configuring power sharing for uplink multi-panel transmission. Aspects of the present disclosure provide various modes of operations, including: semi-static power sharing across panels, dynamic power sharing across panels, and fixed power split across panels. With power sharing for uplink multi-panel transmissions, the UE may transmit the uplink signals from multiple-panels with the same or different transmission power levels. According to aspects of this disclosure, the UE may achieve higher throughput from multi-panel uplink transmissions, at least partially because the multi-panel operation supports higher rank transmissions. In addition, the UE may transmit the same signal from multiple panels using different beams, which may increase the reliability for the uplink transmissions.

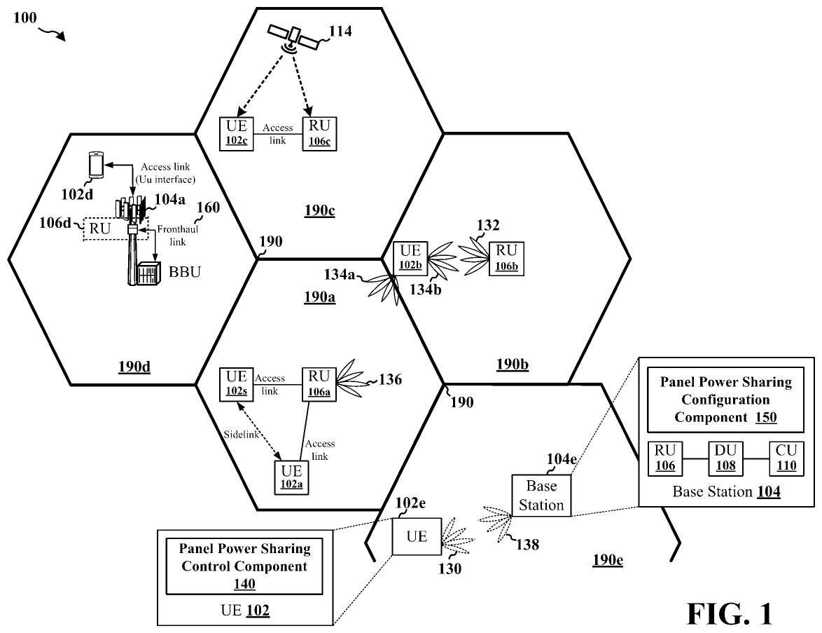

FIG. 1 illustrates a diagram 100 of a wireless communications system associated with a plurality of cells 190. The wireless communications system includes user equipments (UEs) 102 and base stations/network entities 104. Some base stations may include an aggregated base station architecture and other base stations may include a disaggregated base station architecture. The aggregated base station architecture includes a radio unit (RU) 106, a distributed unit (DU) 108, and a centralized unit (CU) 110 that are configured to utilize a radio protocol stack that is physically or logically integrated within a single radio access network (RAN) node. A disaggregated base station architecture utilizes a protocol stack that is physically or logically distributed among two or more units (e.g., RUs 106, DUs 108, CUs 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Each of the RU 106, the DU 108 and the CU 110 may be implemented as virtual units, such as a virtual radio unit (VRU), a virtual distributed unit (VDU), or a virtual central unit (VCU). The base station/network entity 104 (e.g., an aggregated base station or disaggregated units of the base station, such as the RU 106, the DU 108, or the CU 110), may be referred to as a transmission reception point (TRP).

Operations of the base station 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN), which may also be referred to a cloud radio access network (C-RAN). Disaggregation may include distributing functionality across the two or more units at various physical locations, as well as distributing functionality for at least one unit virtually, which may enable flexibility in network designs. The various units of the disaggregated base station architecture, or the disaggregated RAN architecture, may be configured for wired or wireless communication with at least one other unit. For example, the base stations 104a/104e and/or the RUs 106a-106d may communicate with the UEs 102a-102d and 102s via one or more radio frequency (RF) access links based on a Uu interface. In examples, multiple RUs 106 and/or base stations 104 may simultaneously serve the UEs 102, such as by intra-cell and/or inter-cell access links between the UEs 102 and the RUs 106/base stations 104.

The RU 106, the DU 108, and the CU 110 may include (or may be coupled to) one or more interfaces configured to transmit or receive information/signals via a wired or wireless transmission medium. A base station 104 or any of the one or more disaggregated base station units may be configured to communicate with one or more other base stations 104 or one or more other disaggregated base station units via the wired or wireless transmission medium. In examples, a processor, a memory, and/or a controller associated with executable instructions for the interfaces may be configured to provide communication between the base stations 104 and/or the one or more disaggregated base station units via the wired or wireless transmission medium. For example, a wired interface may be configured to transmit or receive the information/signals over a wired transmission medium, such as via the fronthaul link 160 between the RU 106d and the baseband unit (BBU) 112 of the base station 104d associated with the cell 190d. The BBU 112 includes a DU 108 and a CU 110, which may also have a wired interface (e.g., midhaul link) configured between the DU 108 and the CU 110 to transmit or receive the information/signals between the DU 108d and the CU 110d. In further examples, a wireless interface, which may include a receiver, a transmitter, or a transceiver, such as an RF transceiver, configured to transmit and/or receive the information/signals via the wireless transmission medium, such as for information communicated between the RU 106a of the cell 190a and the base station 104e of the cell 190e via cross-cell communication beams 136-138 of the RU 106a and the base station 104e.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RU 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or, in some examples, cross-cell communication beams. For instance, the UE 102b of the cell 190b may communicate with the RU 106a of the cell 190a via a third set of communication beams 134a of the UE 102b and a fourth set of communication beams 136 of the RU 106a. Both real-time and non-real-time features of control plane and user plane communications of the RUs 106 may be controlled by associated DUs 108.

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to a core network. The base stations 104 might relay communications between the UEs 102 and the core network. The base stations 104 may be associated with macrocells for high-power cellular base stations and/or small cells for low-power cellular base stations. For example, the cell 190e may correspond to a macrocell, whereas the cells 190a-190d may correspond to small cells. Small cells include femtocells, picocells, microcells, etc. A cell structure that includes at least one macrocell and at least one small cell may be referred to as a “heterogeneous network.”

Transmissions from a UE 102 to a base station 104/RU 106 are referred to as uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas 114 of the base station 104d of cell 190d to transmit a downlink/forward link communication to the UE 102d or receive an uplink/reverse link communication from the UE 102d based on the Uu interface associated with the access link between the UE 102d and the base station 104d/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, 800, 1600, 2000, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, more or fewer carriers may be allocated to either the uplink or the downlink. A primary component carrier and one or more secondary component carriers may be included in the component carriers. The primary component carrier may be associated with a primary cell (PCell) and a secondary component carrier may be associated with as a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. The sidelink communication/D2D link may also use one or more sidelink channels, such as a physical sidelink broadcast channel (PSBCH), a physical sidelink discovery channel (PSDCH), a physical sidelink shared channel (PSSCH), and/or a physical sidelink control channel (PSCCH), to communicate information between UEs 102a and 102s. Such sidelink/D2D communication may be performed through various wireless communications systems, such as wireless fidelity (Wi-Fi) systems, Bluetooth systems, Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating frequency ranges (FRs) referred to as frequency range 1 (FR1) and frequency range 2 (FR2). FR1 ranges from 410 MHz-7.125 GHz and FR2 ranges from 24.25 GHZ-71.0 GHz, which includes FR2-1 (24.25 GHz-52.6 GHz) and FR2-2 (52.6 GHz-71.0 GHz). Although a portion of FR1 is actually greater than 6 GHz, FR1 is often referred to as the “sub-6 GHz” band. In contrast, FR2 is often referred to as the “millimeter wave” (mmW) band. FR2 is different from, but a near subset of, the “extremely high frequency” (EHF) band, which ranges from 30 GHZ 300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHz-24.25 GHz. Frequency bands within FR3 may include characteristics of FRI and/or FR2. Hence, features of FR1 and/or FR2 may be extended into the mid-band frequencies. Higher operating frequency bands have been identified to extend 5G NR communications above 52.6 GHz associated with the upper limit of FR2. Three of these higher operating frequency bands include FR2-2, which ranges from 52.6 GHZ-71.0 GHZ, FR4, which ranges from 71.0 GHz-114.25 GHz, and FR5, which ranges from 114.25 GHZ-300 GHz. The upper limit of FR5 corresponds to the upper limit of the EHF band. Thus, unless otherwise specifically stated herein, the term “sub-6 GHz” may refer to frequencies that are less than 6 GHZ, within FR1, or may include the mid-band frequencies. Further, unless otherwise specifically stated herein, the term “millimeter wave”, or mmW, refers to frequencies that may include the mid-band frequencies, may be within FR2-1, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of communication beams 132 to the UE 102b in one or more transmit directions of the RU 106b. The UE 102b may receive the downlink beamformed signal based on a second set of communication beams 134b from the RU 106b in one or more receive directions of the UE 102b. In a further example, the UE 102b may also transmit an uplink beamformed signal to the RU 106b based on the second set of communication beams 134b in one or more transmit directions of the UE 102b. The RU 106b may receive the uplink beamformed signal from the UE 102b in one or more receive directions of the RU 106b.

The UE 102b may perform beam training to determine the best receive and transmit directions for the beamformed signals. The transmit and receive directions for the UEs 102 and the base stations 104/RUs 106 might or might not be the same. In further examples, beamformed signals may be communicated between a first base station/RU 106a and a second base station 104e. For instance, the base station 104e of the cell 190e may transmit a beamformed signal to the RU 106a based on the communication beams 138 in one or more transmit directions of the base station 104e. The RU 106a may receive the beamformed signal from the base station 104e of the cell 190e based on the RU communication beams 136 in one or more receive directions of the RU 106a. In further examples, the base station 104e transmits a downlink beamformed signal to the UE 102e based on the communication beams 138 in one or more transmit directions of the base station 104e. The UE 102e receives the downlink beamformed signal from the base station 104e based on UE communication beams 130 in one or more receive directions of the UE 102e. The UE 102e may also transmit an uplink beamformed signal to the base station 104e based on the UE communication beams 130 in one or more transmit directions of the UE 102e, such that the base station 104e may receive the uplink beamformed signal from the UE 102e in one or more receive directions of the base station 104e.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 may be implemented as an IAB node, a relay node, a sidelink node, an aggregated (monolithic) base station with an RU 106 and a BBU 112 that includes a DU 108 and a CU 110, or as a disaggregated base station including one or more RUs 106, DUs 108, and/or CUs 110. A set of aggregated or disaggregated base stations may be referred to as a next generation-radio access network (NG-RAN). In some examples, the UE 102a operates in dual connectivity (DC) with the base station 104e and the base station/RU 106a. In such cases, the base station 104e may be a master node and the base station/RU 160a may be a secondary node.

Uplink/downlink signaling may also be communicated via a satellite positioning system (SPS) 114. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

Still referring to FIG. 1, in certain aspects, any of the UEs 102 may include a panel power sharing control component 140 configured to obtain, from the network entity 104, a panel-power-sharing configuration that schedules uplink transmissions associated with TCI states using antenna panels of the UE 102. The panel power sharing control component 140e of the UE 102 determines, based on a power sharing mode indicated in the panel-power-sharing configuration, respective transmission power levels of the antenna panels of the UE 102. The UE 102 then transmits the uplink transmissions from the antenna panels using the respective transmission power levels according to the determination.

In certain aspects, any of the base stations 104 or a network entity of the base station (104e) may include a panel power sharing configuration component 150 configured to provide, to the UE 102, a panel-power-sharing configuration that schedules uplink transmissions associated with transmission configuration indication, TCI, states using antenna panels of the UE 102. The base station 104e then receives the uplink transmissions from the antenna panels using respective transmission power levels determined based on a power sharing mode indicated in the panel-power-sharing configuration.

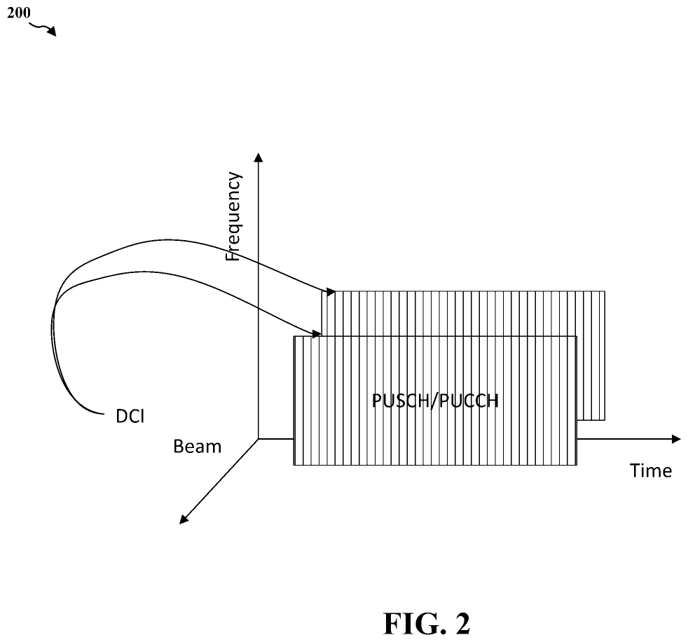

Accordingly, FIG. 1 describes a wireless communication system that may be implemented in connection with aspects of one or more other figures described herein, such as aspects illustrated in FIGS. 2-30. Further, although the following description may be focused on 5G NR, the concepts described herein may be applicable to other similar areas, such as 5G-Advanced and future versions, LTE, LTE-advanced (LTE-A), and other wireless technologies, such as 6G.

A network entity, such as the base station 104, may schedule the UE 102 to transmit uplink signals, e.g., physical uplink shared channels (PUSCHs) or physical uplink control channels (PUCCHs), from multiple antenna panels, e.g., two or more antenna panels. The network entity may schedule such multi-panel transmissions based on a single downlink control information (DCI) or multiple DCIs, as illustrated in FIGS. 2-4.

FIG. 2 illustrates an example of a single-DCI based multi-panel uplink transmissions, in accordance with aspects of this disclosure. As shown, for the single-DCI based multi-panel PUSCH/PUCCH, in some implementations, the UE 102 may multiplex the PUSCH/PUCCH from different antenna panels in spatial domain multiplexing (SDM) manner. In some implementations, the UE 102 may transmit the PUSCH from different panels based on single-frequency network (SFN) manner: the UE 102 transmits the same PUSCH/PUCCH in both panels in fully overlapped time and frequency domain resources. The network entity 104 may transmit the DCI by PDCCH or configure the DCI by radio resource control (RRC) signaling.

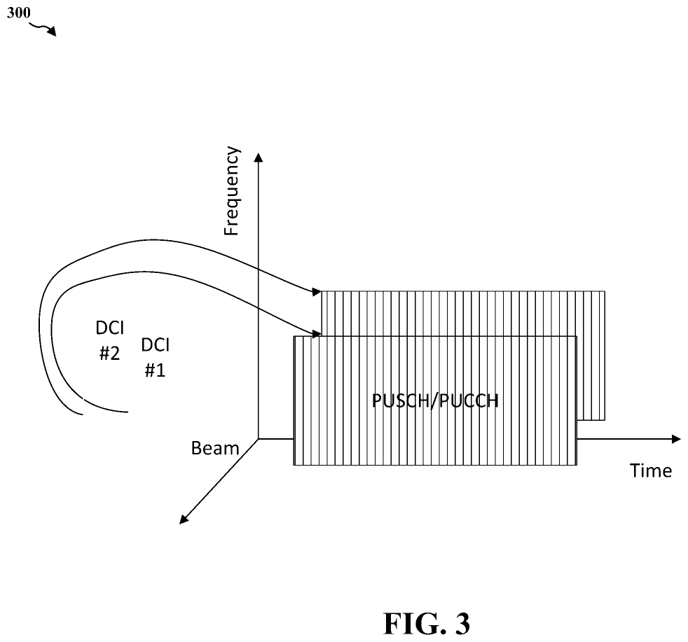

FIG. 3 illustrates an example of a multi-DCI based multi-panel uplink transmissions (e.g., PUSCH or PUCCH), in accordance with aspects of this disclosure. As shown, the network entity 104 transmits two DCIs scheduling two PUSCHs/PUCCHs independently. The two PUSCHs/PUCCHs may fully overlap or partially overlap in time domain with fully/partially overlapped or non-overlapped frequency domain resources. The network entity 104 may transmit each DCI by PDCCH or configure each DCI by RRC signaling.

Usually, a UE needs to follow the maximum transmission power limitation for the power class that the UE has reported, e.g., 23 dBm for power class 3, 26 dBm for power class 2, or other power limitations for other corresponding power classes. Conventional practice does not specify per-panel power sharing or limitations for multi-panel uplink transmissions. The present disclosure provides various examples, methods, and techniques to address the power sharing for the uplink signals across the multiple antenna panels regarding the maximum transmission power limitations. In addition to the power sharing or splitting among multiple antenna panels, the present disclosure further addresses power level variations in cases of two DCIs separated by a time gap (thus the second DCI may require power sharing updates while the UE already initiated transmissions per the first DCI).

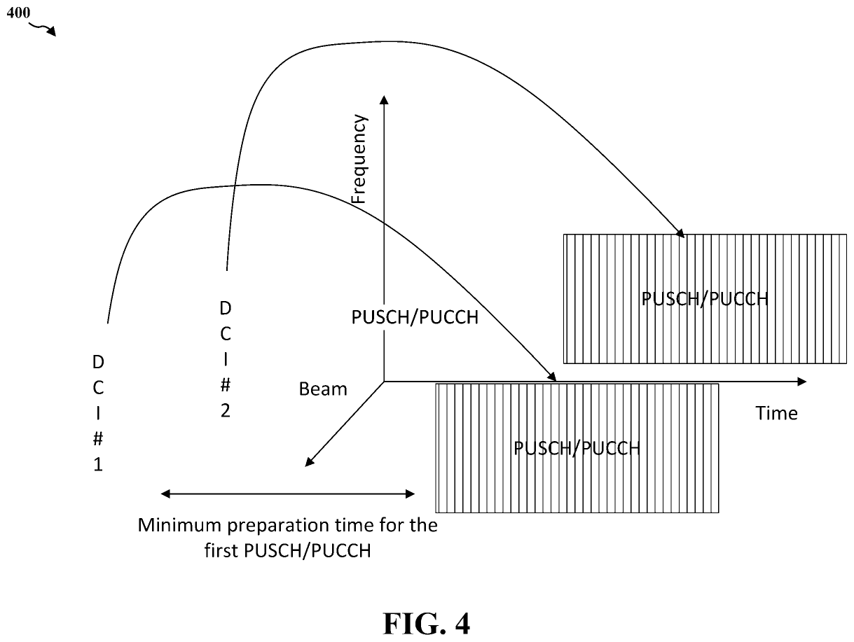

FIG. 4 illustrates an example of a transmission power selection for a first uplink transmission per a first DCI with regard to unknown future scheduling of a second uplink transmission per a second DCI, in accordance with aspects of this disclosure. In addition, for multi-DCI based multi-panel transmission, the network entity may transmit the two DCIs with different timeline. As shown in FIG. 4, the network entity 104 may transmit the first DCI scheduling the first PUSCH and the second DCI scheduling the second PUSCH.

In FIG. 4, the network entity 104 transmits the first DCI earlier than the second DCI. Correspondingly, the UE 102 will transmit the first PUSCH earlier than the second PUSCH. Then when the UE 102 determines the transmission power for the first PUSCH, the UE 102 might not have detected or decoded the second DCI completely. The present disclosure enables the UE 102 to determine the transmission power for the first PUSCH with possible future adjustment (e.g., “looking-ahead”) capabilities for the second (or the coming) PUSCHs/PUCCHs. As discussed in details below, various power level determination modes may be used to address such situations.

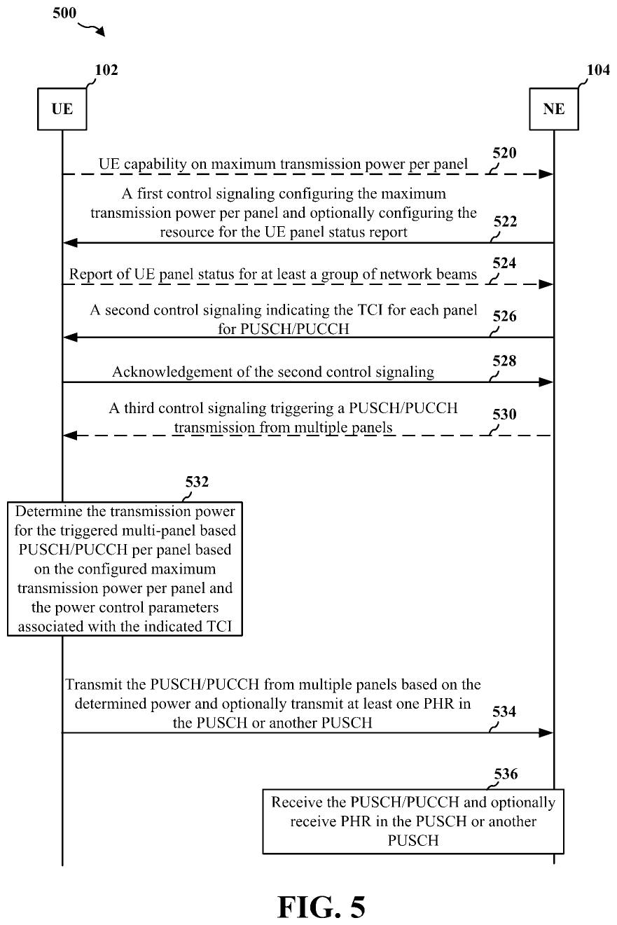

FIG. 5 illustrates an example signaling diagram 500 between a UE 102 (e.g., the UE 102e) and a network entity, NE 104 (e.g., the base station 104e) for semi-static power sharing across panels, in accordance with aspects of this disclosure. As shown, the UE 102 may implementationally transmit 520 the UE capability on the maximum transmission power per panel to the NE 104. The NE 104 sends 522 a first control signaling that configures the maximum transmission power per panel in the UE 102. The first control signaling may implementationally configure the resource for the UE panel status report.

In some implementations, the UE 102 reports 520 one or more capabilities on maximum (supported) transmission power per panel to the network entity. In some implementations, the one or more capabilities also indicate maximum (supported) total transmission power across all panel(s) to the network entity. In some implementations, the network entity receives the one or more capabilities from a core network (e.g., Access and Mobility Management Function (AMF)). In yet some other implementations, the network entity receives the one or more capabilities from another base station (e.g., gNB or eNB). Based on the UE capability, the network entity may configure 522 the maximum transmission power for each panel by the first control signaling, e.g., RRCReconfiguration.

The UE 102 then implementationally reports 524 the UE panel status for at least a group of network beams to the NE 104. The NE 104 sends 526 a second control signaling indicating the TCI for each panel for uplink transmissions (PUSCH/PUCCH). The UE 102 then sends 528 an acknowledgement of the second control signaling to the NE 104. For example, the UE 102 may report 524 the UE panel status for at least a group of gNB beams. The network entity may identify the maximum transmission power for each TCI state corresponding to the network entity beams. Then the NE 104 provides 526 the TCI indication by the second control signaling, e.g., MAC CE or DCI. The UE transmits 528 an acknowledgement (ACK) of the TCI indication signaling after decoding the second control signaling successfully. The network entity may transmit a third control signaling triggering a PUSCH/PUCCH. The UE may transmit the PUSCH/PUCCH from multiple panels.

In some cases, the NE 104 implementationally transmits 530 a third control signaling that triggers a PUSCH/PUCCH transmission from the multiple panels of the UE 102. The UE 102 determines 532 the transmission power for the triggered multi-panel based PUSCH/PUCCH per panel based on the configured maximum transmission power per panel and the power control parameters associated with the indicated TCI. For example, the UE 102 performs 532 the uplink power control procedure for the PUSCH/PUCCH for each panel independently based on the maximum transmission power for each panel and power control parameters associated with the indicated TCI. The network entity 104 may be one gNB or different gNBs.

The UE 102 transmits 534 the PUSCH/PUCCH from multiple antenna panels based on the determined power levels. In some cases, the UE 102 implementationally transmits 534 at least one power headroom report (PHR) in the PUSCH or another PUSCH to the NE 104. The NE 104 receives 536 the PUSCH/PUCCH, as well as the PHR in another PUSCH from the UE 102.

In aspects herein, for single-DCI based scheduling, the first indicated TCI indicates the first TCI in the indicated TCI codepoint in the MAC CE for TCI activation, and second indicated TCI indicates the second TCI in the indicated TCI codepoint in the MAC CE for TCI activation. Note that uplink signal corresponding to a panel may be defined as uplink signal indicated or associated with an ID or an index, e.g., coresetPoolIndex, uplink transmission process index, uplink antenna group index, UE capability set index, SRS resource set index and so on.

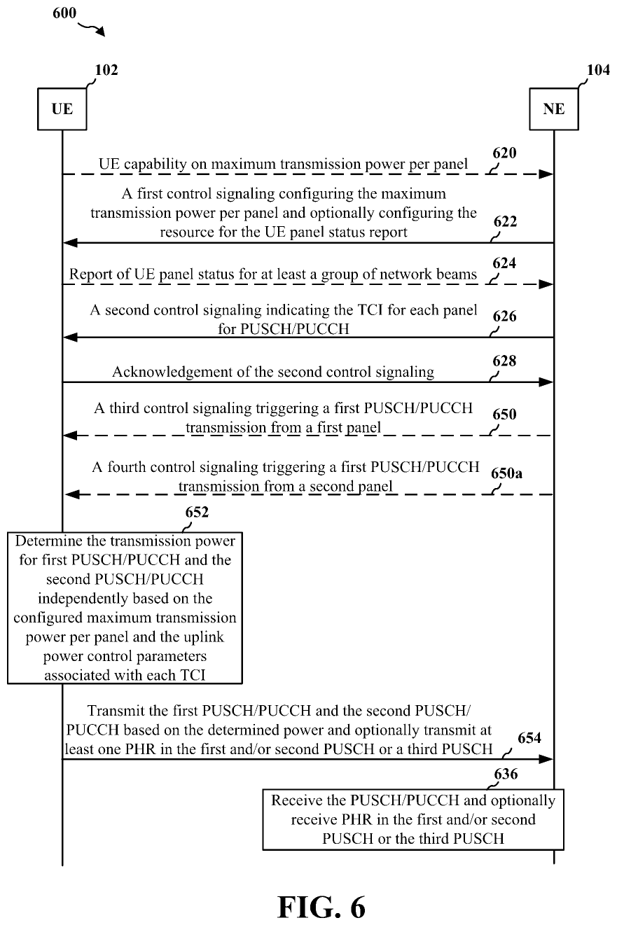

FIG. 6 illustrates an example signaling diagram 600 between a UE (the UE 102) and a network entity (the NE 104) for semi-static power sharing across panels, in accordance with aspects of this disclosure. As shown, similar to the signaling diagram 500, the UE 102 may implementationally transmit 620 the UE capability on the maximum transmission power per panel to the NE 104. The NE 104 sends 622 a first control signaling that configures the maximum transmission power per panel in the UE 102. The first control signaling may implementationally configure the resource for the UE panel status report. The UE 102 then implementationally reports 624 the UE panel status for at least a group of network beams to the NE 104. The NE 104 sends 626 a second control signaling indicating the TCI for each panel for uplink transmissions (PUSCH/PUCCH). The UE 102 then sends 628 an acknowledgement of the second control signaling to the NE 104.

Unlike the signaling diagram 500, the NE 104 transmits (650 and 650a) two control signals respective for uplink transmissions from each panel. As shown, the NE 104 transmits 650 a third control signaling that triggers a first PUSCH/PUCCH transmission from the first panel of the UE 102. The NE 104 transmits 650a a fourth control signaling that triggers a second PUSCH/PUCCH transmission from the second panel of the UE 102.

The UE 102 then determines 652 the transmission power levels for the first PUSCH/PUCCH (and the second PUSCH/PUCCH) independently based on the configured maximum transmission power per panel and the uplink power control parameters associated with each TCI. For example, the UE 102 determines 652 the transmission power for the first PUSCH and the second PUSCH based on the maximum transmission power for the corresponding panel independently.

The UE 102 transmits 654 the first PUSCH/PUCCH and the second PUSCH/PUCCH based on the determined power and implementationally transmits at least one PHR in the first and/or the second PUSCH or a third PUSCH. For example, the UE 102 may transmit 654 the two PUSCH/PUCCH from two different antenna panels. In some cases, the UE 102 may transmit 654 one or more than one PHR in the first PUSCH and/or the second PUSCH or in a third PUSCH in another serving cell (if configured/activated carrier aggregation (CA) operations). The NE 104 receives 636 the PUSCH/PUCCH and implementationally receives PHR in another PUSCH from the UE 102.

In aspects of this disclosure, for multi-DCI based scheduling, the first indicated TCI indicates the indicated TCI for the signals associated with the first CORESETPoolIndex, and second indicated TCI indicates the indicated TCI for the signals associated with the second CORESETPoolIndex.

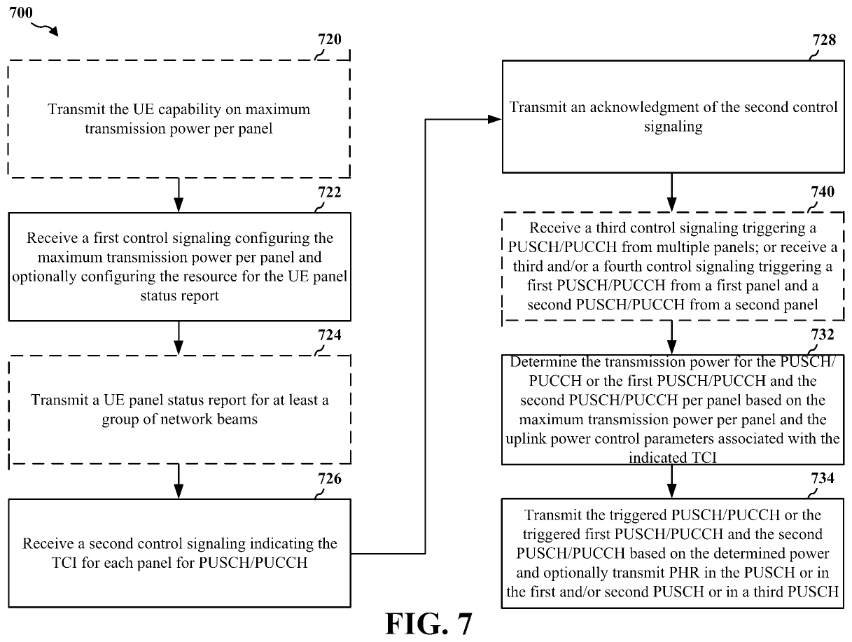

FIG. 7 is a flowchart of a method 700 of wireless communications by a UE for semi-static power sharing across panels, corresponding to the signaling diagrams 500 and 600 of FIGS. 5 and 6. As shown, the UE implementationally transmits 720 the UE capability on maximum transmission power per panel to the network entity. The UE then receives 722 a first control signaling configuring the maximum transmission power per panel and implementationally configuring the resource for the UE panel status report.

The UE implementationally transmits 724 a UE panel status report for at least a group of network beams. The UE receives 726 a second control signaling indicating the TCI for each panel for uplink transmissions (e.g., PUSCH/PUCCH). The UE transmits 728 an acknowledgement of the second control signaling. The UE may receive 740 a third control signaling that triggers a PUSCH/PUCCH from multiple antenna panels. In some cases, the UE may receive 740 a third and/or a fourth control signaling that trigger(s) a first uplink transmission (e.g., PUSCH or PUCCH) from a first panel and a second uplink transmission from a second panel.

The UE determines 732 the transmission power levels for the corresponding uplink transmissions per panel based on the maximum transmission power per panel and the uplink control parameters associated with the indicated TCI. The UE transmits 734 the triggered uplink transmissions based on the determined power levels to the network entity. The uplink transmissions may include the triggered PUSCH/PUCCH or the triggered first PUSCH/PUCCH and the second PUSCH/PUCCH. In some cases, the UE implementationally transmits 734 PHR in the PUSCH or in the first and/or second PUSCH or in a third PUSCH.

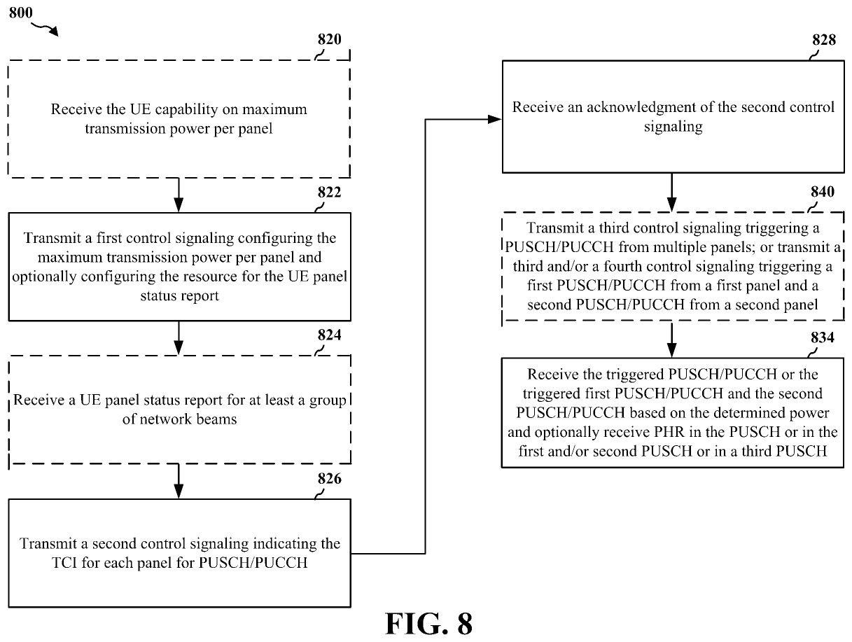

FIG. 8 is a flowchart of a method of wireless communications by a network entity for semi-static power sharing across panels, corresponding to the signaling diagrams 500 and 600 of FIGS. 5 and 6. The network entity may receive 820 the UE capability on maximum transmission power per panel. The network entity transmits 822 a first control signaling configuring the maximum transmission power per panel. In some cases, the first control signaling implementationally configures the resource for the UE panel status report. If so configured in the UE, the network entity may receive 824 a UE panel status report for at least a group of network beams.

The network entity transmits 826 a second control signaling indicating the TCI for each panel for uplink transmissions (e.g., PUSCH or PUCCH). The network entity receives 828 an acknowledgement of the second control signaling. In some cases, the network entity transmits 840 a third control signaling triggering a PUSCH/PUCCH from multiple panels; or transmit a third and/or a fourth control signaling triggering a first PUSCH/PUCCH from a first panel and a second PUSCH/PUCCH from a second panel. The network entity receives 834 the triggered PUSCH/PUCCH or the triggered first PUSCH/PUCCH and the second PUSCH/PUCCH based on the determined power. In some cases, the network entity receives PHR in the PUSCH or in the first and/or second PUSCH or in a third PUSCH.

In aspects of this disclosure, an RRC signaling may indicate a RRC (re-) configuration message from gNB to UE, or a system information block (SIB), where the SIB may be an existing SIB (e.g., SIB1) or a new SIB (e.g., SIB J, where J is an integer, e.g., greater than 2) transmitted by gNB.

In an embodiment regarding UE capability on semi-static power sharing across panels, the UE transmits (520, 720) a UE capability indicating at least one of the following elements: whether the UE supports semi-static power sharing across panels; and the maximum transmission power per panel or for each panel. The UE may report the UE capability per feature set, per band, per band combination, or per UE.

In an embodiment regarding the first control signaling and UE behavior for semi-static power sharing, the network entity transmits (522, 822) the first control signaling configuring the maximum transmission power per panel or for each panel, or the power split ratio across panels. Then the UE may perform the power control with power scaling per panel for uplink signal corresponding to a panel. For uplink signal(s) in the serving cell(s) from the same panel, the UE may calculate the target transmission power based on the uplink power control parameters.

In one symbol, if the total transmission power for the uplink signal(s) exceeds the maximum transmission power for the panel, the UE performs power scaling for the uplink signal(s) with lower priority, where the priority for the uplink signal(s) may be predefined or configured or indicated by the network entity. In one example, the priority is defined as follows.

In one example, the priority for power scaling for signals from the same panel may be predefined as follows (from highest priority to lowest priority):
1. PRACH transmission on the PCell or PSCell;
2. PUCCH or PUSCH transmissions with larger priority index;
3. For PUCCH or PUSCH transmissions with same priority index;
4. PUCCH transmission with HARQ-ACK information, and/or scheduling request (SR), and/or link recovery request (LRR), and/or PUSCH transmission with HARQ-ACK information of the priority index, and/or Listen Before Talk (LBT) failure, and/or MAC CE for beam failure recovery;
5. PUCCH transmission with CSI or PUSCH transmission with CSI;
6. PUSCH transmission without HARQ-ACK information of the priority index or CSI and, for Type-2 random access procedure, PUSCH transmission on the PCell; and
7. SRS transmission, with aperiodic SRS having higher priority than semi-persistent and/or periodic SRS, or PRACH transmission on a serving cell other than the PCell.

The above list of priority examples may vary depending on particular implementations. In some implementations, not all the listed priority orders are applied. In some implementations, the priority order for some signals may be different.

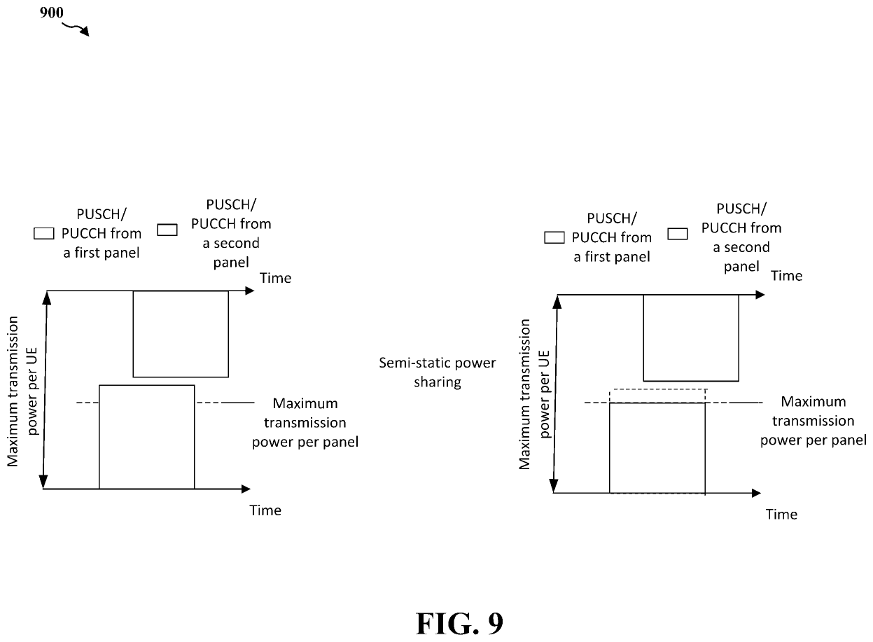

FIG. 9 illustrates an example 900 of semi-static power sharing across panels, in accordance with aspects of this disclosure. As shown, the UE performs power scaling for each panel (the first panel and the second panel) independently based on the configured maximum transmission power per panel or for each panel, or the configured power split ratio across panels. That is, when the UE has the initial transmission power level in the first panel exceeding the maximum transmission power allowed, the UE may reduce the transmission power level (or otherwise scaled) to the allowed limit. Since the power scaling is based on the transmission power for UL signals from the same panel, the network entity and UE may need to maintain the same understanding on the UE panel for each uplink signal, e.g., the UE panel for an indicated TCI index.

In an embodiment regarding the UE panel and TCI association based on UE report, the UE reports the UE panel index (e.g., an index indicating a set of antenna ports, an SRS resource or a set of SRS resource), for at least a group of network entity beams. For each group of network entity beams, the UE may report at least two Synchronization Signal Block Resource Indexes (SSBRIs) or Channel State Information Reference Signal Resource Indexes (CRIs), toward which it may transmit the at least two uplink signals simultaneously.

In some implementations, the association or correspondence of the UE panel with a SSB/CRI is fixed. For example, the first SSB/CRI in a group corresponds to the first UE panel, and the second SSB/CRI in a group corresponds to the second UE panel. In some implementations, the UE reports the panel index for each SSB/CRI in a group. If or when the network entity transmits, to the UE, an indication indicating a joint/DL TCI, a joint/UL TCI or a spatial relation info with source or reference signal as the corresponding SSB/CRI, for DL reception or UL transmission, the UE applies the corresponding panel in the latest UE report before the indication.

In some implementations, the UE transmit the UE report by MAC CE. In some implementations the UE transmit the UE report as uplink control information (UCI) report included in or multiplexed on PUCCH or PUSCH.

In some implementations, the network entity may configure such UE report by the first control signaling, e.g., RRC signaling with CSI-ReportConfig. The network entity may transmit a MAC CE or DCI activating or triggering the UE report. In some implementations, the UE may trigger the UE report if the UE detects the panel status or association for the group of network entity beams changes. The UE may transmit a PUCCH resource or a scheduling request (SR) requesting an uplink resource for transmitting such UE report, where the PUCCH resource or the SR may be configured by the network entity by RRC signaling. If the UE does not receive a configured PUCCH resource or SR for such UE report, the UE may transmit PRACH requesting the uplink resource. In some implementations, if the UE does not receive an uplink resource for transmitting such UE report after transmitting the PUCCH resource or the SR (implementationally for certain of times), the UE may transmit PRACH requesting the uplink resource.

In some implementations, the UE may apply a first TCI switching delay for a known TCI and a second TCI switching delay for an unknown TCI state as defined in 3GPP TS 38.133 section 8.10. If the indicated TCI states are not included in the at least one group of network entity beams reported in the UE report within a given time window, the UE applies the second TCI switching delay; otherwise, the UE applies the first TCI switching delay. The time window may be predefined, e.g., 3 ms before the TCI indication signaling, or be configured by the network entity by RRC signaling, or be reported by the UE via UE capability.

In some implementations, if the network entity indicates the UE to use a first TCI and a second TCI to transmit an UL transmission (e.g., in a SDM method), or if the network entity indicates the UE to use a first TCI and a second TCI to transmit one or more UL transmission (e.g., in a SFN method), and if the one of the first TCI and a second TCI is unknown TCI, the UE may transmit the UL transmission or the one or more UL transmission by the first and the second TCI after the second TCI switching delay, and/or the UE does not transmit the UL transmission or the one or more UL transmission by the first and the second TCI until the second TCI switching delay passes.

In an embodiment regarding the UE panel and TCI association based on network entity configuration, the network entity may configure the UE panel index based on the TCI indication. In some implementations, the network entity configures the UE panel index implicitly based on the order of indicated TCI states, e.g., the first indicated TCI corresponds to the first panel and the second indicated TCI corresponds to the second panel. In some implementations, the network entity configures the UE panel index explicitly for each indicated TCI state. The network entity may configure the UE panel index for each indicated TCI state by RRC signaling, MAC CE, or DCI.

In some implementations, if the UE panel index for the indicated TCI is not aligned with the UE panel index for the network entity beam, the UE may transmit a NACK for the corresponding indicated TCI to the network entity; otherwise, the UE may transmit an ACK for the corresponding indicated TCI to the network entity.

In some implementations, the UE may apply a first TCI switching delay for a known TCI and a second TCI switching delay for an unknown TCI state as defined in 38.133 section 8.10. If the UE panel index for a TCI is different from the UE panel index reported by the UE in beam report, the UE applies the second TCI switching delay; otherwise, the UE applies the first TCI switching delay.

In an embodiment regarding the PUSCH/PUCCH transmission with PHR report, the UE may transmit the PUSCH(s)/PUCCH(s) based on the determined transmission power per panel. For single-DCI based multi-panel PUSCH transmission, the UE may transmit at least one PHR in the scheduled PUSCH or another PUSCH in another serving cell (if configured or activated CA operation). For multi-DCI based multi-panel PUSCH transmission, the UE may transmit PHR in a first PUSCH and/or a second PUSCH in the serving cell or transmit PHR in a third PUSCH in another serving cell. In some implementations, the UE transmits the PHR repeatedly in both of the first PUSCH and the second PUSCH. In some implementations, the UE transmits different parts of at least one PHR in both of the first PUSCH and the second PUSCH.

In some implementations, the UE transmits a single PHR to the network entity. The UE transmits the PHR based on the maximum transmission power per UE and the total actual or reference transmission power across panels. The UE may report the maximum transmission power across panels in addition to a power headroom in a PHR. In one example, the UE calculates the power headroom (PH) as follows:

$$PH = {P}_{c , max} - 10 {log}_{10} {\sum }_{j = 1}^{N} 1 {0}^{0.1 {P}_{Tx}^{( j )}}$$

Where, P_{c,max} indicates the maximum transmission power for the PUSCH/PUCCH across panels in dBm;

$${P}_{Tx}^{( j )}$$

indicates the actual or reference transmission power for panel j or indicated TCI state j in dBm; N indicates the number of panels (activated by the UE or equipped in UE device) or the number of indicated/activated TCI states from the network entity.

In some implementations, the UE transmits a PHR calculated based on a UE panel to the network entity. The panel status or association with a TCI state may be fixed, e.g., the one corresponding to the first indicated TCI state. Alternatively, the UE selects the panel based on the timeline or order of the PUSCH, e.g., UE transmits the PHR for the PUSCH that starts earlier/later or ends earlier/later. Alternatively, the UE selects the panel based on the CORESETPoolIndex of the scheduling control resource set (CORESET) for the PUSCH for the PHR report or the CORESETPoolIndex configured in a configured UL grant (configuration) for the PHR report. The UE selects the panel associated with the CORESETPoolIndex for the PUSCH or the configured UL grant for the PHR report. Alternatively, the network entity configures or indicates the UE panel index for PH calculation by RRC signaling, MAC CE or DCI.

The UE transmits the PHR based on the maximum transmission power and the actual or reference transmission power for the panel. The UE may report the maximum transmission power for the panel or across panels in addition to a power headroom in a PHR. The UE may report the panel index, e.g., TCI index within the indicated TCI states to the network entity in a PHR. In one example, the UE calculates the PH as follows:

$$PH = {P}_{c , max}^{( j )} - {P}_{Tx}^{( j )}$$

Where,

$${P}_{c , max}^{( j )}$$

indicates the maximum transmission power for the PUSCH/PUCCH for the selected panel j or indicated TCI state j in dBm;

$${P}_{Tx}^{( j )}$$

indicates the actual or reference transmission power for the selected panel j or indicated TCI state j in dBm.

In some implementations, the UE transmits a single PHR based on PH for each UE panel. The UE calculates the per panel PH based on the maximum transmission power for the panel and the actual or reference transmission power for the panel, and calculates the PH based on the per panel PH. In one example, the UE calculates the PH for panel j as follows:

$$PH = {P}_{c , max}^{( j )} - {P}_{Tx}^{( j )}$$

Where,

$${P}_{c , max}^{( j )}$$

indicates the maximum transmission power for the PUSCH/PUCCH for the panel j or indicated TCI state j in dBm;

$${P}_{Tx}^{( j )}$$

indicates the actual or reference transmission power for panel j or indicated TCI state j in dBm. Then the reported PH may be the average or minimum or maximum value of the PH from each panel. In one example, the UE calculates the PH as follows:

$$PH = min \{ {PH}^{( 1 )} , {PH}^{( 2 )} , … , {PH}^{( N )} \}$$

In another example, the UE calculates the PH as follows:

$$PH = max \{ {PH}^{( 1 )} , {PH}^{( 2 )} , … , {PH}^{( N )} \}$$

In another example, the UE calculates the PH as follows:

$$PH = 10 {log}_{10} \frac{1}{N} {\sum }_{j = 1}^{N} 1 {0}^{0.1 {PH}^{( j )}}$$

Where N indicates the number of panels or indicated TCI states.

In some implementations, the UE may report the average or maximum or minimum maximum transmission power across panels, and/or total maximum transmission power across panels, and/or the panel index (TCI index within the indicated TCI states) for PH calculation in a PHR additionally.

In some implementations, the UE transmits multiple PHRs, e.g., multiple MAC CEs, or single PHR with multiple PHs, e.g., single MAC CE with multiple PHs, each of them corresponding to each of all the UE panels used for the PUSCH transmission or all indicated TCI states for the PUSCH transmission. The UE calculates the per panel PH based on the maximum transmission power for the panel and the actual or reference transmission power for the panel.

In one example, the UE calculates PH for panel j as follows:

$${PH}^{( j )} = {P}_{c , max}^{( j )} - {P}_{Tx}^{( j )}$$

Where,

$${P}_{c , max}^{( j )}$$

indicates the maximum transmission power for the panel j or indicated TCI state j;

$${P}_{Tx}^{( j )}$$

indicates the actual or reference transmission power for panel j or indicated TCI state j.

The UE may further transmit the maximum transmission power per panel and/or the panel index (TCI index within the indicated TCI states) for PH calculation in the PHR(s). The UE may transmit the PHR(s) as repetitions in different PUSCHs or transmit different PHR in different PUSCHs, e.g., the first PHR calculated based on the first indicated TCI or the first PUSCH or a PUSCH associated with the first CORESETPoolIndex, and the second PHR calculated based on the second indicated TCI or the second PUSCH or a PUSCH associated with the second CORESETPoolIndex.

In some implementations, the UE transmits multiple PHR(s) or multiple PHs in a PHR for each UE panel and across panels. Compared to the previous implementations, the difference is that in this implementation, in addition to the per-panel report in previous implementations, the UE may transmit per-UE PHR using calculation examples in previous implementations.

In some implementations, the network entity may configure the PH calculation and report scheme by RRC signaling, or MAC CE, or DCI. The network entity may configure whether to report per-panel PH and/or per UE PH. In one example, the network entity may configure whether to report two PHs/PHRs by an RRC parameter explicitly, e.g., enableTwoPhr or phrReportScheme. Then the UE may always report the PHR based on the configured scheme, e.g., one of the implementations from previous implementations.

In some implementations, the network entity may configure panel-specific and/or UE-specific PHR triggering events. The UE may trigger a PHR for a panel or for the UE or transmit a scheduling request (SR), e.g., PUCCH or PRACH, to request uplink resource for PHR, if at least one of the following events happens: 1) Event 1: The PHR prohibit timer for the panel or for the UE, e.g., phr-ProhibitTimer, expires or has expired and the pathloss for the panel or for the UE has changed more than a configured threshold, e.g., phr-Tx-PowerFactorChange dB, for at least one RS used as pathloss reference for one activated Serving Cell of any MAC entity of which the active downlink bandwidth part (BWP) is not dormant BWP since the last transmission of a PHR in this MAC entity when the MAC entity has uplink resources for new transmission;
2) Event 2: The timer for periodic PHR for the panel or for the UE, e.g., phr-PeriodicTimer, expires;
3) Event 3: Upon configuration or reconfiguration of the power headroom reporting functionality for the panel or for the UE by upper layers, e.g., RRC layer, which is not used to disable the function;
4) Event 4: Activation of a secondary cell (SCell) with multi-panel transmission of any MAC entity with configured uplink of which firstActiveDownlinkBWP-Id is not set to dormant BWP;
5) Event 5: Activation of a secondary cell group (SCG) with multi-panel transmission;
6) Event 6: Addition of the primary secondary cell (PSCell) with multi-panel transmission except if the SCG is deactivated (i.e. PSCell is newly added or changed);
7) Event 7: The PHR prohibit timer for the panel or for the UE, e.g., phr-ProhibitTimer, expires or has expired, when the MAC entity has UL resources for new transmission, and the following is true for any of the activated Serving Cells of any MAC entity with configured uplink: there are UL resources allocated for transmission or there is a PUCCH transmission on this cell, and the required power backoff for the panel or for the UE due to power management for this cell has changed more than a configured threshold, e.g., phr-Tx-PowerFactorChange dB, since the last transmission of a PHR when the MAC entity had UL resources allocated for transmission or PUCCH transmission on this cell.
8) Event 8: Upon switching of activated BWP from dormant BWP to non-dormant DL BWP of an SCell of any MAC entity with configured uplink; and
9) Event 9: If the maximum power emission (MPE) related report is enabled, e.g., mpe-Reporting-FR2 is configured, and the prohibit timer for the panel or for the UE for MPE report, e.g., mpe-ProhibitTimer, is not running: the measured power management power reduction (P-MPR) applied to meet FR2 MPE requirements is equal to or larger than a first configured threshold for the panel or for the UE, e.g., mpe-Threshold, for at least one activated FR2 Serving Cell since the last transmission of a PHR in this MAC entity; or the measured P-MPR applied to meet FR2 MPE requirements has changed more than a second configured threshold for the panel or for the UE, e.g., phr-Tx-PowerFactorChange dB, for at least one activated FR2 Serving Cell since the last transmission of a PHR due to the measured P-MPR applied to meet MPE requirements being equal to or larger than the first configured threshold for the panel or for the UE, e.g., mpe-Threshold, in this MAC entity.

If the conditions or events for more than one types of PHs or PHRs triggering listed above are met, the UE transmits the more the one types of PHs or PHRs. If the condition or event for only one type of PH or PHR triggering is met, the UE transmits the one PH or PHR.

In some implementations, the network entity may configure at least one of the following parameters for each panel (indicated TCI state or CORESETPoolIndex) by RRC signaling:
1. PHR prohibit timer, e.g., phr-ProhibitTimer
2. Pathloss change threshold, e.g., phr-Tx-PowerFactorChange
3. PHR periodicity, e.g., phr-PeriodicTimer
4. Flag of MPE based PHR report, e.g., mpe-Reporting-FR2
5. MPE prohibit timer, e.g., mpe-ProhibitTimer
6. MPE threshold, e.g., mpe-Threshold

In some implementations, the network entity may configure more than one PHR configurations, e.g., phr-Config, in a cell group configuration (e.g., CellGroupConfig or MAC-CellGroupConfig) where each PHR configuration may correspond to one panel or one indicated TCI or one CORESETPoolIndex. The network entity may configure another PHR configuration for per UE PHR report.

In some implementations regarding the UE reported PH calculation scheme, the UE reports its capability of whether it supports single PHR/PH report or multiple PHRs/PHs report. In some implementations, the UE reports which reporting schemes (e.g., in the previous implementations) are supported by the UE. For multi-DCI based multi-panel PUSCH, the UE may further report whether it supports PHR repetitions in multiple PUSCHs or PHR partitions in multiple PUSCHs.

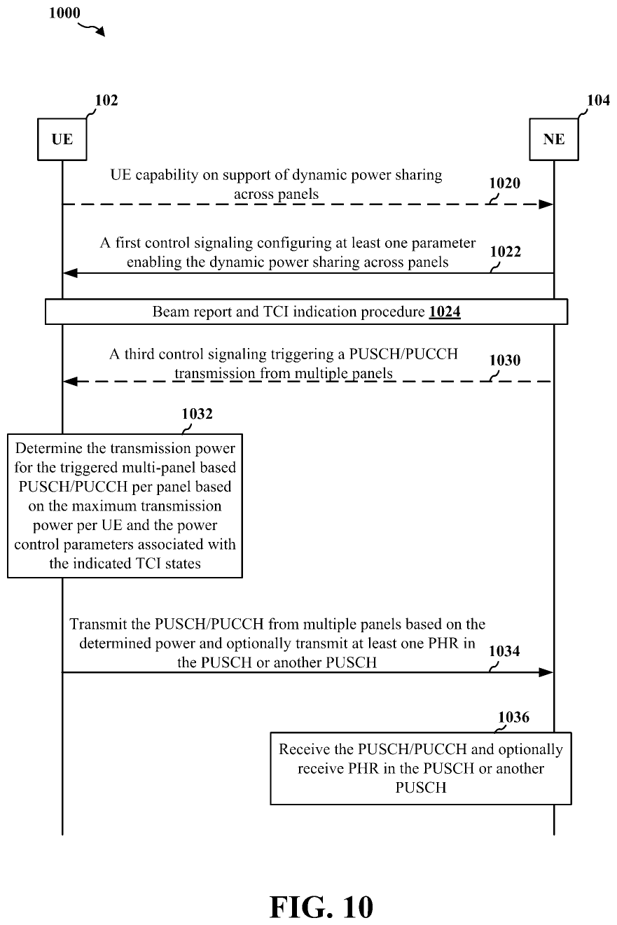

FIG. 10 illustrates an example signaling diagram 1000 between a UE and a network entity for dynamic-power sharing across panels, in accordance with aspects of this disclosure. Different from the semi-static power sharing procedure in FIG. 5, the UE in the dynamic-powering sharing mode may report 1020 the UE capability on whether the UE supports dynamic power sharing, and the UE may further indicate whether the UE supports dynamic power sharing with “looking-ahead” of uplink signals scheduled after the UE receives a first DCI. The NE 104 transmits 1022 the first control signaling, e.g., RRC signaling, to enable the dynamic power sharing in the UE 102. The UE 102 and the NE 104 performs 1024 beam report and TCI indication procedure.

In some cases, the UE 102 receives 1030 a third control signaling that triggers a PUSCH/PUCCH transmission from multiple panels. The UE performs 1032 the power control for the PUSCH/PUCCH(s) transmitted from each panel independently and performs 1032 power scaling for at least one of the PUSCH/PUCCH(s) if the total transmission power across panels exceeds the maximum transmission power per UE. The UE transmits 1034 the PUSCH/PUCCH from multiple panels based on the determined power and optionally, the UE may transmit 1034 at least one PHR in the PUSCH or another PUSCH, with or without “looking-ahead” capability in the PUSCH with multiple panel transmission or another PUSCH in another serving cells. The NE 104 receives 1036 the PUSCH/PUCCH and the optional PHR in another PUSCH.

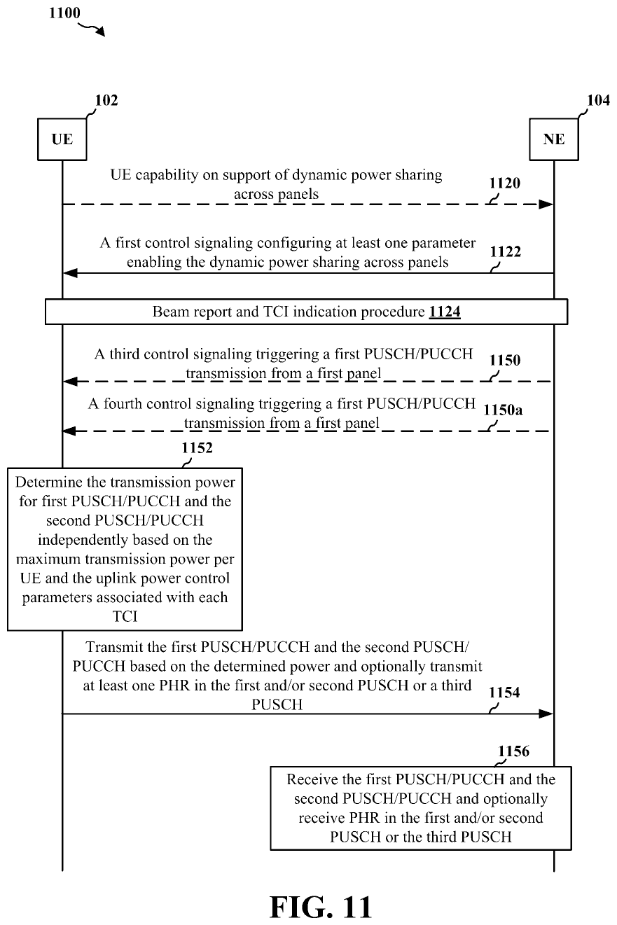

FIG. 11 illustrates an example signaling diagram 1100 between a UE and a network entity for dynamic-power sharing across panels, in accordance with aspects of this disclosure. The signaling diagram 1100 is similar to the signaling diagram 1000 in that the UE 102 optionally transmits 1120 the UE capability on support of dynamic power sharing across panels. The NE 104 transmits 1122 a first control signaling that configures at least one parameter enabling the dynamic power sharing across panels. The UE 102 and the NE 104 then perform 1124 beam report and TCI indication procedures.

Different from the signaling diagram 1000, the NE 104 transmits (1150 and 1150a) two control signalings, e.g., a third control signaling and a fourth control signaling triggering two PUSCH/PUCCH from two different panels. The UE 102 determines 1152 the transmission power for first PUSCH/PUCCH and the second PUSCH/PUCCH independently based on the maximum transmission power per UE and the uplink power control parameters associated with each TCI. The UE 102 may transmit 1154 the first PUSCH/PUCCH and the second PUSCH/PUCCH based on the determined power.

In some cases, the UE 102 may optionally transmit at least one PHR in the first and/or second PUSCH or a third PUSCH. The UE 102 may transmit one or more than one PHR in the first PUSCH and/or the second PUSCH or in a third PUSCH in another serving cell. The NE 104 receives 1156 the first PUSCH/PUCCH and the second PUSCH/PUCCH and optionally receive PHR in a third PUSCH.

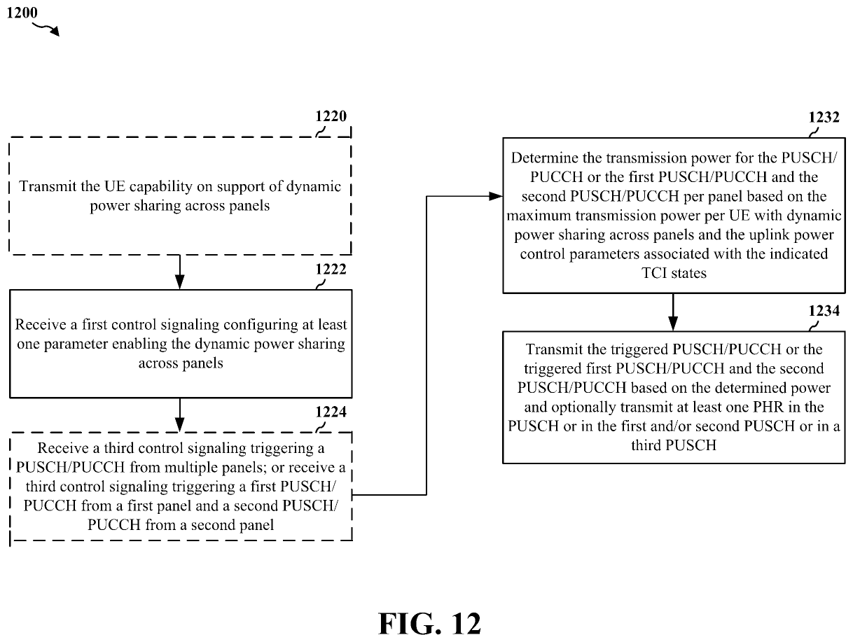

FIG. 12 is a flowchart of a method 1200 of wireless communications by a UE for dynamic-power sharing across panels, corresponding to the signaling diagrams 1000 and 1100 of FIGS. 10 and 11. As shown, the UE optionally transmits 1220 the UE capability on support of dynamic power sharing across panels. For example, the UE transmits 1220 a UE capability indicating at least one of the elements: whether the UE supports dynamic power sharing across panels; whether the UE supports power control for an uplink signal, e.g., PUSCH/PUCCH/SRS, with “looking-ahead” of other uplink signals scheduled later. The UE may report the UE capability per feature set, per band, per band combination, or per UE.

The UE receives 1222 a first control signaling configuring at least one parameter enabling the dynamic power sharing across panels. For example, the at least one parameter may include a first parameter enabling or disabling the dynamic power sharing across panels; a second parameter enabling or disabling the power control for uplink signal with “looking-ahead” of another uplink signals scheduled later.

The UE receives 1224 a third control signaling triggering a PUSCH/PUCCH from multiple panels; or receive a third control signaling triggering a first PUSCH/PUCCH from a first panel and a second PUSCH/PUCCH from a second panel. The UE determines 1232 the transmission power for the PUSCH/PUCCH or the first PUSCH/PUCCH and the second PUSCH/PUCCH per panel based on the maximum transmission power per UE with dynamic power sharing across panels and the uplink power control parameters associated with the indicated TCI states.

For example, with dynamic power sharing across panels enabled, the UE may calculate the target transmission power for PUSCH/PUCCH for each panel based on the uplink power control parameters associated with the indicated TCI for each panel. Note that if one indicated TCI is for a panel, it may mean that reference signal or source signal in the indicated TCI is associated with the panel. Then the UE may perform power scaling for the PUSCH/PUCCH based on the priority for power scaling for the uplink signals, where the UE performs power scaling for the uplink signals with lowest priority. The priority may be predefined or configured by the network entity by RRC signaling or MAC CE or DCI.

The UE transmits 1234 the triggered PUSCH/PUCCH or the triggered first PUSCH/PUCCH and the second PUSCH/PUCCH based on the determined power and optionally transmit at least one PHR in the PUSCH or in the first and/or second PUSCH or in a third PUSCH. In an example, the priority for power scaling for signals may be predefined as follows (from highest priority to lowest priority, actual priorities may vary depending on applications):
1. PRACH transmission on the PCell or PSCell
2. PUCCH or PUSCH transmissions with larger priority index
3. For PUCCH or PUSCH transmissions with same priority index
4. PUCCH transmission with HARQ-ACK information, and/or scheduling request (SR), and/or link recovery request (LRR), and/or PUSCH transmission with HARQ-ACK information of the priority index, and/or Listen Before Talk (LBT) failure, and/or MAC CE for beam failure recovery
5. PUCCH transmission with CSI or PUSCH transmission with CSI
6. PUSCH transmission without HARQ-ACK information of the priority index or CSI and, for Type-2 random access procedure, PUSCH transmission on the PCell
7. SRS transmission, with aperiodic SRS having higher priority than semi-persistent and/or periodic SRS, or PRACH transmission on a serving cell other than the PCell

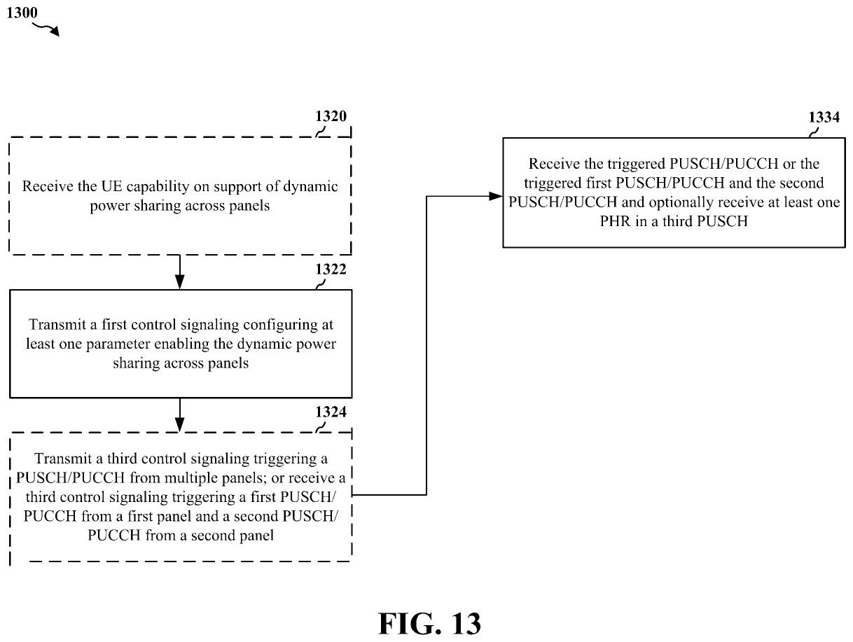

FIG. 13 is a flowchart of a method of wireless communications by a network entity for dynamic-power sharing across panels, complementary to the method 1200 and corresponding to the signaling diagrams 1000 and 1100 of FIGS. 10 and 11. As shown, the network entity optionally receives 1320 the UE capability on support of dynamic power sharing across panels. The network entity transmits 1322 a first control signaling configuring at least one parameter enabling the dynamic power sharing across panels.

The network entity optionally transmits 1324 a third control signaling triggering a PUSCH/PUCCH from multiple panels; or receive a third control signaling triggering a first PUSCH/PUCCH from a first panel and a second PUSCH/PUCCH from a second panel. The network entity receives 1334 the triggered PUSCH/PUCCH or the triggered first PUSCH/PUCCH and the second PUSCH/PUCCH and optionally receive at least one PHR in a third PUSCH.

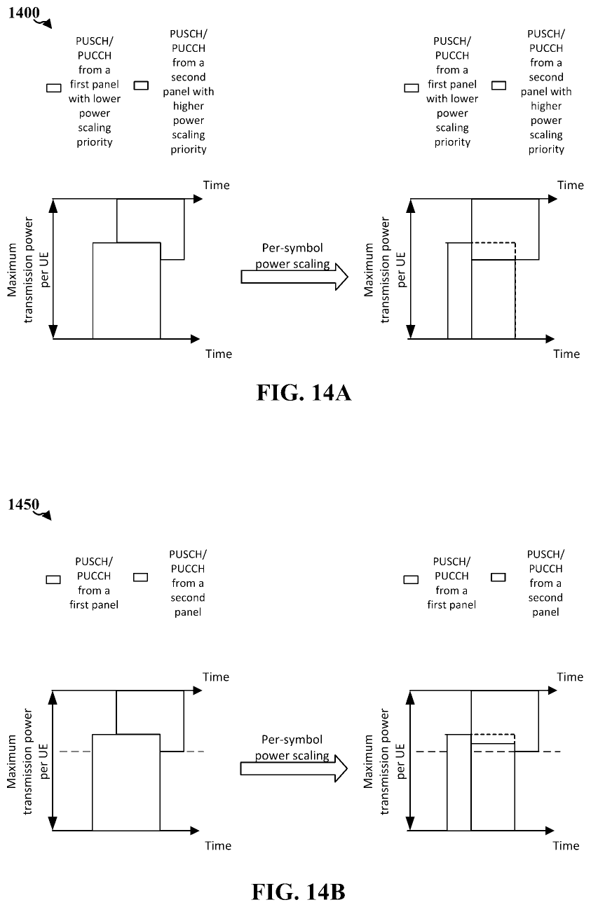

FIG. 14A illustrates an example 1400 of per-symbol power scaling for uplink transmissions from one panel with lower priority, in accordance with aspects of this disclosure. In an embodiment, the UE performs the per-symbol power scaling for PUSCH/PUCCH transmitted via one panel when the total transmission power for the PUSCH/PUCCH(s) transmitted via multiple panels exceeds the maximum transmission power per UE.

For single-DCI based multi-panel transmission, in some implementations, the UE determines the power scaling priority for a panel based on the number of layers for each panel, and/or indicated TCI states for each panel, and/or measured pathloss for each panel. In one example, the priority for a panel with large number of layers is higher than the priority for a panel with smaller number of layers.

In another example, the priority for the first indicated TCI is higher than the priority for the second indicated TCI. In another example, the priority for the panel with smaller measured pathloss is higher than the priority for the panel with larger measured pathloss.

In some implementations, the UE may determine the power scaling priority for a panel at a timing based on the number of UL transmission to in a serving cell or across serving cells transmitted via the panel at the timing. In some implementations, the UE may determine the power scaling priority for a panel at a timing based on the number of indicated TCI state(s) for or associated with the panel at the timing.

For single-DCI based multi-panel transmission, in some other implementations, the network entity configures or indicates the power scaling priority for each panel or each indicated TCI states. The network entity may configure the priority by RRC signaling or MAC CE or DCI. In one example, the network entity may indicate the priority by a DCI field indicating whether the UE may perform power scaling for the PUSCH/PUCCH from the first panel or the second panel.

For multi-DCI based multi-panel transmission, in some implementations, the UE determines the power scaling priority for the first and the second PUSCH/PUCCH based on the Modulation and coding scheme (MCS) for the PUSCH, and/or number of layers for the PUSCH, and/or indicated TCI states for the PUSCH/PUCCH, and/or associated CORESETPoolIndex for the PUSCH/PUCCH, and/or measured pathloss for the PUSCH/PUCCH, and/or the transmission content for the PUSCH/PUCCH based on the predefined priority rule for power scaling for uplink signals across serving cells, and/or transmission timeline or order for the PUSCH/PUCCH. In one example, the priority for a PUSCH with larger MCS is higher than the priority for a PUSCH with smaller MCS.

In another example, the priority for a PUSCH with large number of layers is higher than the priority for a PUSCH with smaller number of layers. In another example, the priority for the PUSCH/PUCCH with the first indicated TCI is higher than the priority for PUSCH/PUCCH with the second indicated TCI. In another example, the priority for the PUSCH/PUCCH with the first CORESETPoolIndex is higher than the priority for PUSCH/PUCCH with the second CORESETPoolIndex.

In another example, the priority for the PUSCH/PUCCH with smaller measured pathloss is higher than the priority for the PUSCH/PUCCH with larger measured pathloss. In another example, the priority for the PUSCH/PUCCH that starts or ends earlier is higher than the priority for the PUSCH/PUCCH that starts or ends later. In another example, the priority for the PUSCH/PUCCH with scheduling PDCCH that starts or ends earlier is higher than the priority for the PUSCH/PUCCH with scheduling PDCCH that starts or ends later.

For multi-DCI based multi-panel transmission, in some other implementations, the network entity configures or indicates the power scaling priority for each PUSCH/PUCCH or each indicated TCI states or each CORESETPoolIndex. The network entity may configure the priority by RRC signaling or MAC CE or DCI. In one example, the network entity may indicate the priority by a DCI field indicating whether the scheduled PUSCH/PUCCH is with a higher priority or not.

FIG. 14B illustrates an example 1450 of per-symbol power scaling for uplink transmissions from all panels with lower priority, in accordance with aspects of this disclosure. In an embodiment regarding per-symbol power scaling for PUSCH/PUCCH from all panels, the UE performs the per-symbol power scaling for PUSCH/PUCCH from all panels when the total transmission power for the PUSCH/PUCCH from multiple panels exceeds the maximum transmission power per UE.

In some implementations, the power scaling factor for each panel may be the same. The UE determines the power scaling factor per panel based on the total target transmission power across panels and the maximum transmission power of the UE. In one example, the linear power scaling factor for each panel is calculated as follows:

$$s = \frac{{P}_{c , max}^{′}}{{\sum }_{j = 1}^{N} {P}_{Tx}^{′ ( j )}}$$

Where P′_{c,max} indicates the linear maximum transmission power of the UE;

$${P}_{Tx}^{′ ( j )}$$

denotes the target linear transmission power for panel j; N refers to the number of panels used for the PUSCH/PUCCH transmission in a symbol.

In some implementations, the scaled power for each panel may be the same. The UE determines the power scaling factor for each panel based on the target transmission power for the panel, total target transmission power across panels and the maximum transmission power of the UE. In one example, the linear power scaling factor for panel j is calculated as follows:

$${s}_{j} = max ( \frac{{\sum }_{j = 1}^{N} {P}_{Tx}^{′ ( j )} - {P}_{c , max}^{′}}{{P}_{Tx}^{′ ( j )}} , 0 )$$

Then the channel coding for the UCI is based on modulation order and coding rate for the selected PUSCH.

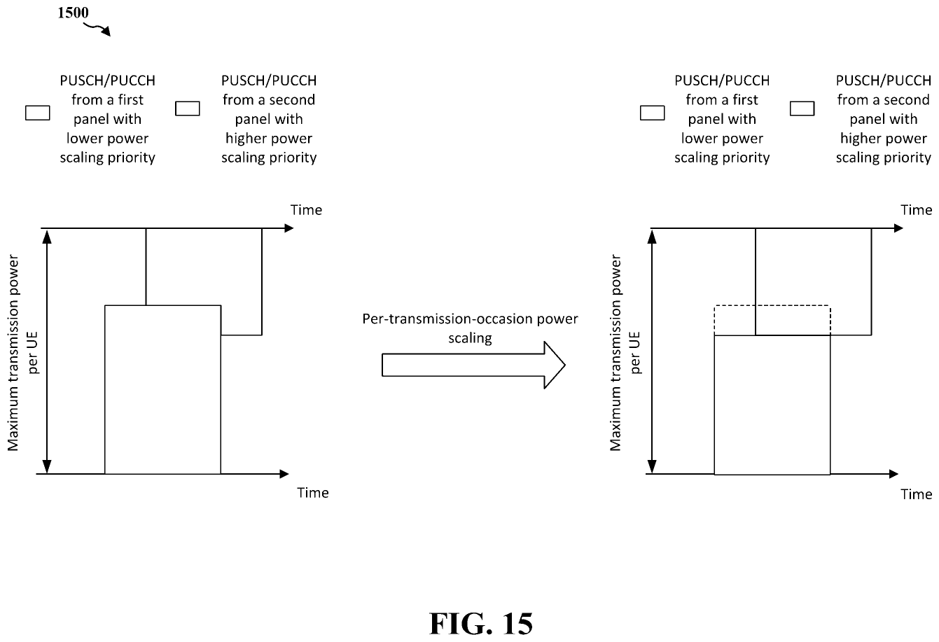

FIG. 15 illustrates an example 1500 of per-transmission-occasion power scaling for uplink transmissions from one panel with lower priority, in accordance with aspects of this disclosure.

In an embodiment regarding per-transmission-occasion power scaling for PUSCH/PUCCH from one panel, the UE performs the per-transmission-occasion power scaling for PUSCH/PUCCH from one panel when the total transmission power for any symbol of the transmission occasion of the PUSCH/PUCCH from multiple panels exceeds the maximum transmission power of the UE.

In the same or other embodiment, a first UL transmission (e.g., PUSCH or PUCCH) transmitted from one panel may overlap with one or more transmission occasions (e.g., repetitions) of a second UL transmission (e.g., PUSCH or PUCCH) transmitted from another panel, where the first UL transmission overlaps with a first symbol of a first transmission occasion and a second symbol of a second transmission occasion. If so and if total transmission power of the first symbol and that of the second symbol (both) exceed the maximum transmission power of the UE, the UE performs power scaling for the first transmission occasion and the second transmission occasion respectively. The UE determines the priority for the PUSCH/PUCCH from each panel based on the previous example implementations.

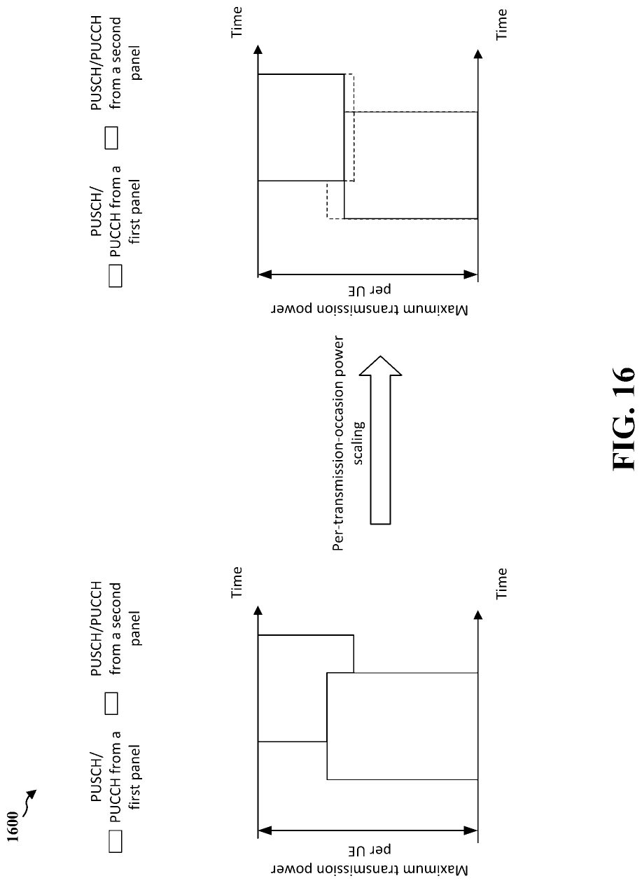

FIG. 16 illustrates an example 1600 of per-transmission-occasion power scaling for uplink transmissions from all panels, in accordance with aspects of this disclosure. As shown, the UE performs power scaling on the uplink transmissions on both panels so that the sum of the respective transmission power levels equals to (or is not greater than) the maximum transmission power per UE. In an embodiment regarding per-transmission-occasion power scaling for PUSCH/PUCCH from all panels, the UE performs the per-transmission-occasion power scaling for PUSCH/PUCCH from all panels when the total transmission power for any symbol of the transmission occasion of the PUSCH/PUCCH from multiple panels exceeds the maximum transmission power of the UE.

In some embodiments, a first UL transmission (e.g., PUSCH or PUCCH) transmitted from one panel may overlap with one or more transmission occasions (e.g., repetitions) of a second UL transmission (e.g., PUSCH or PUCCH) transmitted from another panel, where the first UL transmission overlaps with a first symbol of a first transmission occasion and a second symbol of a second transmission occasion. If so and if total transmission power of the first symbol and that of the second symbol (both) exceed the maximum transmission power of the UE, the UE performs power scaling for the first PUSCH, the first transmission occasion, and the second transmission occasion respectively. In some embodiments, the UE may determine the power scaling factor for the PUSCH/PUCCH from each panel using examples in the previous implementations.

In an embodiment regarding the UE-determined time-domain granularity for power scaling for PUSCH/PUCCH from one panel or all panels, the UE reports its capability of whether it supports dynamic power sharing for a first uplink signal from a first panel with “looking-ahead” of the PDCCH scheduling a second uplink signal overlapped with the first uplink signal in time domain from a second panel within a given time window. The time window may be predefined as the time before the minimum preparation time for the first uplink signal, where the minimum preparation time may be predefined, e.g., 28 symbols, or be reported by the UE via UE capability, or be configured by the network entity by RRC signaling.

If the UE supports the “looking-ahead” capability and the first uplink signal and the second uplink signal meets their corresponding timeline requirement, the UE performs per-transmission-occasion power scaling discussed above; otherwise, the UE performs per-symbol power scaling discussed above, or alternatively the UE determines that this is an error case and may not transmit the first and/or the second uplink signal, e.g., the network entity may schedule the first and the second uplink signal based on the timeline requirement.

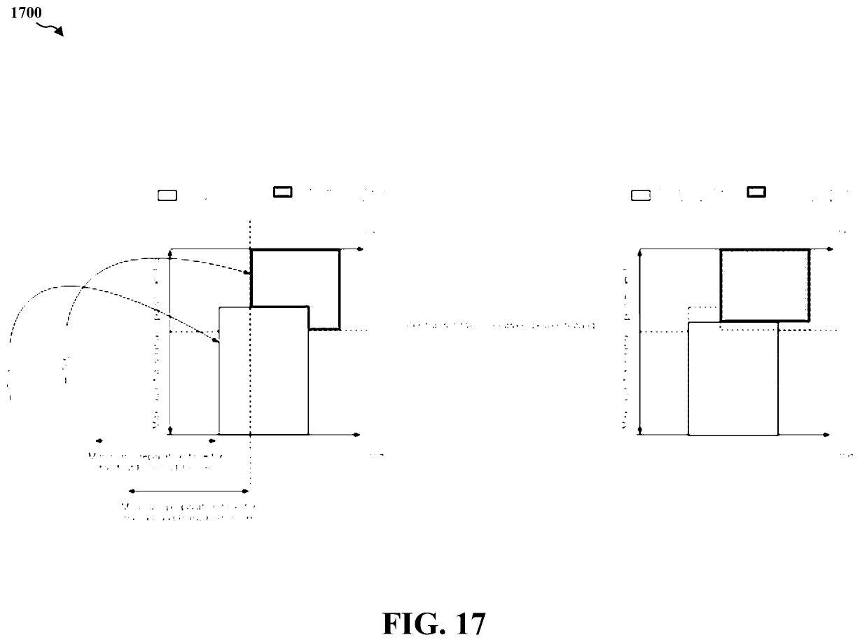

FIG. 17 illustrates an example 1700 of per-transmission-occasion power scaling when the timeline requirement is met, in accordance with aspects of this disclosure. As shown, when the UE receives two DCIs each scheduling an uplink transmission, the UE may need time to adjust the power levels for each panel. The timeline requirement may involve a minimum preparation time for each uplink transmission. When there is sufficient time gap between the DCI and the respective uplink transmission (no less than the minimum preparation time), the UE performs per-transmission-occasion power scaling such that the sum of the uplink transmissions by the multiple panels equals to or not greater than the maximum transmission power allowed per UE.

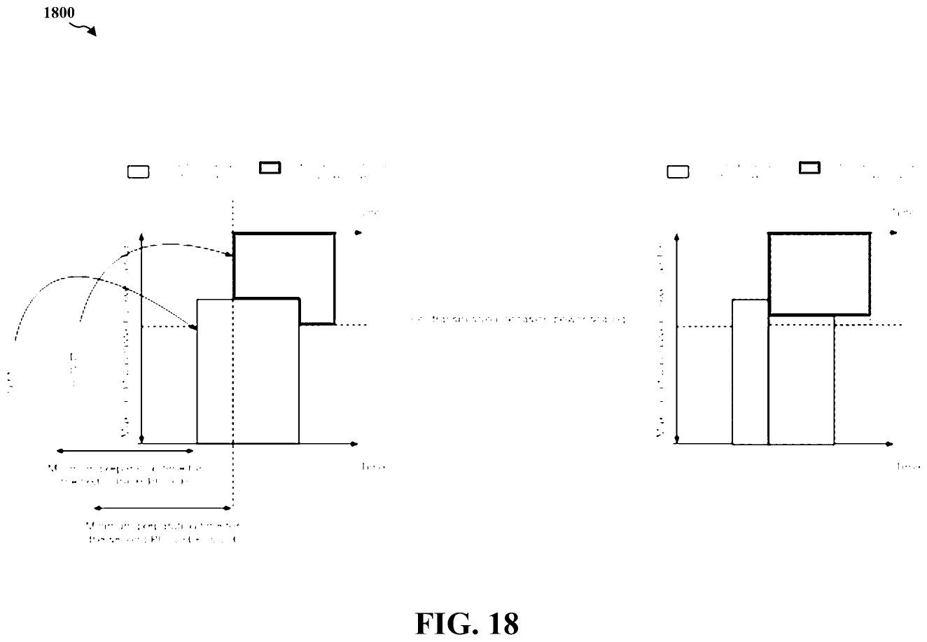

FIG. 18 illustrates an example 1800 of the per-symbol transmission power scaling for the first uplink transmission and per-transmission-occasion power scaling for the second uplink transmission when the timeline requirement is met for the first uplink transmission but not met for the second uplink transmission, in accordance with aspects of this disclosure. As shown, unlink the example 1700, the UE performs power scaling when the uplink transmissions from the second panel starts, when the starting time has a time gap from the corresponding DCI no less than the minimum preparation time for the second uplink transmission.

In an embodiment regarding the PUSCH/PUCCH transmission with PHR report, the UE may transmit the PUSCH(s)/PUCCH(s) based on the determined transmission power per panel. The UE may transmit one or more than one PHR with per UE and/or per panel PH, and maximum transmission power per UE and/or per panel as discussed above.

For a UE with symbol-level power scaling, the UE may process additional steps to determine the PHR, since the maximum transmission power for the PUSCH/PUCCH and the transmission power for the PUSCH/PUCCH may be different.

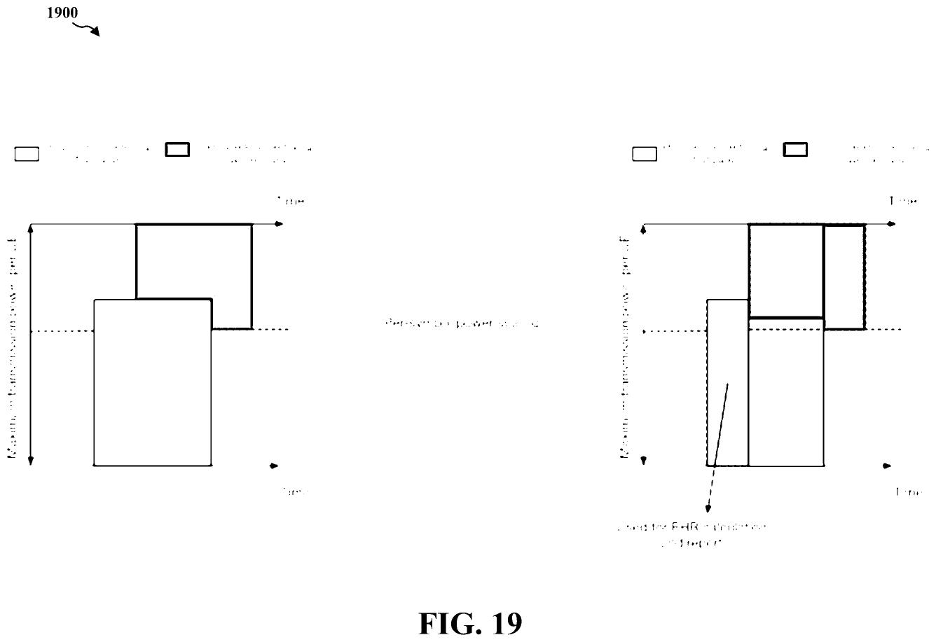

FIG. 19 illustrates an example 1900 of power headroom report (PHR) calculation based on the first symbol of one transmission occasion, in accordance with aspects of this disclosure. As shown, the PHR calculation is based on the first symbol for symbol-level power scaling. For example, the UE calculates and reports the PHR based on the maximum transmission power for the PUSCH/PUCCH and the actual or reference transmission power for the PUSCH/PUCCH in the first symbol.

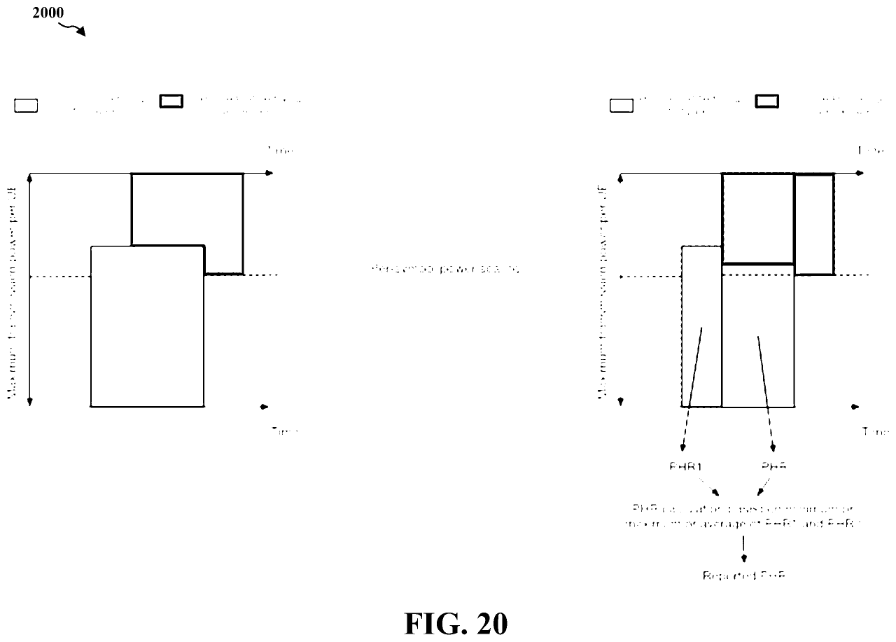

FIG. 20 illustrates an example 2000 of PHR calculation based on the whole transmission occasion with single PHR report, in accordance with aspects of this disclosure. As shown, the UE calculates the PHR based on the minimum, the maximum, or the average of PHR1 and PHR2. In some implementations, the UE calculates and reports the PHR based on the maximum transmission power for the PUSCH/PUCCH and the actual or reference transmission power for the PUSCH/PUCCH in the whole transmission occasion. In some implementations, the UE may transmit the minimum, maximum or average PH calculated from each symbol and the minimum, maximum or average maximum transmission power for the PUSCH from each symbol. In some implementations, the UE may report multiple PHs or PHRs, where each PH or PHR corresponds to a transmission power.

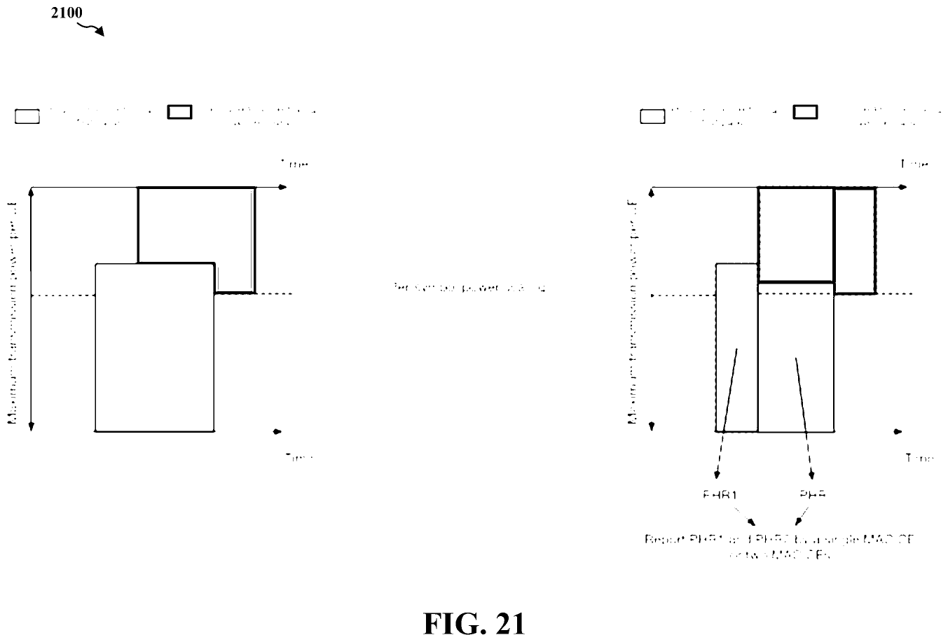

FIG. 21 illustrates an example 2100 of PHR calculation based on the whole transmission occasion with multiple PHRs report, in accordance with aspects of this disclosure. As shown, the UE reports PHR1 and PHR2 by a single MAC CE or respective MAC CEs.

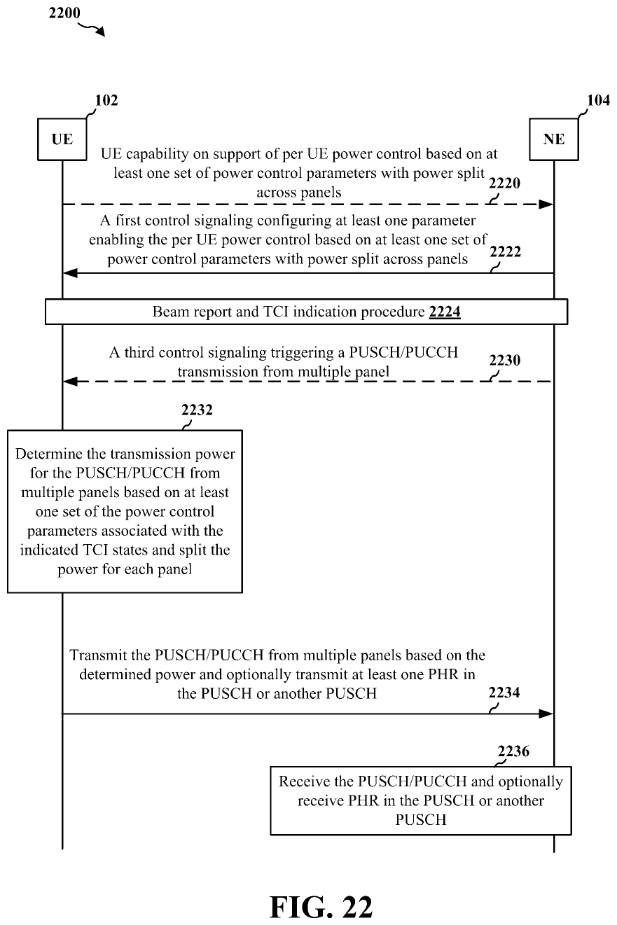

In another power sharing mode, the UE may perform power control with power split per panel, as discussed in relation to FIGS. 22-26.

FIG. 22 illustrates an example signaling diagram 2200 between a UE and a network entity for per UE power control with power split per panel, in accordance with aspects of this disclosure. As shown, the UE 102 may report 2220 the UE capability on whether it supports per-UE power control with power split for each panel. The UE 102 may further report 2220 the maximum transmission power per panel.

The NE 104 transmits 2222 the first control signaling, e.g., RRC signaling, enabling the per-UE power control with power split for each panel. The UE 102 and the NE 104 performs 2224 the beam report and TCI indication procedure. In some cases, the NE 104 transmits 2230 a third control signaling triggering a PUSCH/PUCCH transmission from the multiple panels in the UE 102.

The UE 102 determines 2232 the transmission power for the PUSCH/PUCCH from multiple panels based on at least one set of uplink power control parameters associated with at least one of the indicated TCI states and then splits the determined power for each panel. The UE 102 transmits 2234 the PUSCH/PUCCH from multiple panels based on the determined power and optionally transmit at least one PHR in the PUSCH or another PUSCH. The NE 104 receives 2236 the PUSCH/PUCCH and optionally receive PHR in another PUSCH.

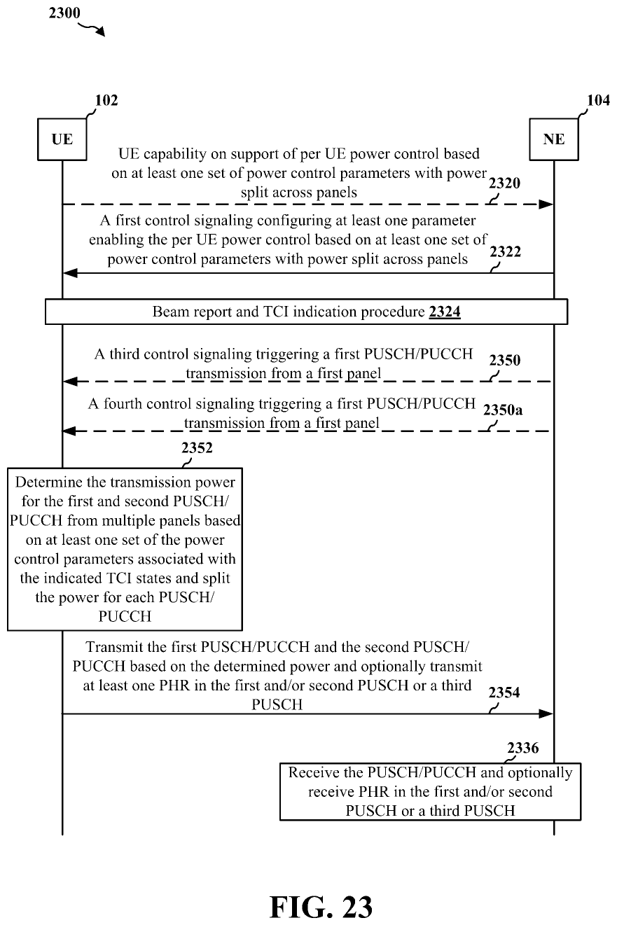

FIG. 23 illustrates an example signaling diagram 2300 between a UE and a network entity for per UE power control with power split per panel, in accordance with aspects of this disclosure. Similar to the signaling diagram 2200, the UE 102 optionally transmits 2320 the UE capability on support of per UE power control based on at least one set of power control parameters with power split across panels. The UE 102 receives 2322 a first control signaling configuring at least one parameter enabling the per UE power control based on at least one set of power control parameters with power split across panels. The UE 102 and the NE 104 performs 2324 beam report and TCI indication procedures.

Different from the signaling diagram 2200, in the signaling diagram 2300, the NE 104 transmits (2350 and 2350a) two control signalings, e.g., a third control signaling and a fourth control signaling triggering two PUSCH/PUCCH from two different panels. For example, the NE 104 transmits 2350 a third control signaling triggering a first PUSCH/PUCCH transmission from a first panel. The NE 104 transmits 2350a a fourth control signaling triggering a first PUSCH/PUCCH transmission from a first panel.

The UE 102 determines 2352 the total transmission for the first PUSCH and the second PUSCH and then splits the transmission power for each PUSCH/PUCCH from each panel. For example, the UE 102 determines the transmission power for the first and second PUSCH/PUCCH from multiple panels based on at least one set of the power control parameters associated with the indicated TCI states and split the power for each PUSCH/PUCCH. The UE 102 transmits 2354 the first PUSCH/PUCCH and the second PUSCH/PUCCH based on the determined power and optionally transmit at least one PHR in the first and/or second PUSCH or a third PUSCH. In some cases, the UE 102 may transmit one or more than one PHR in the first PUSCH and/or the second PUSCH or in a third PUSCH in another serving cell. The NE 104 receives 2336 the PUSCH/PUCCH and optionally receive PHR in another PUSCH.

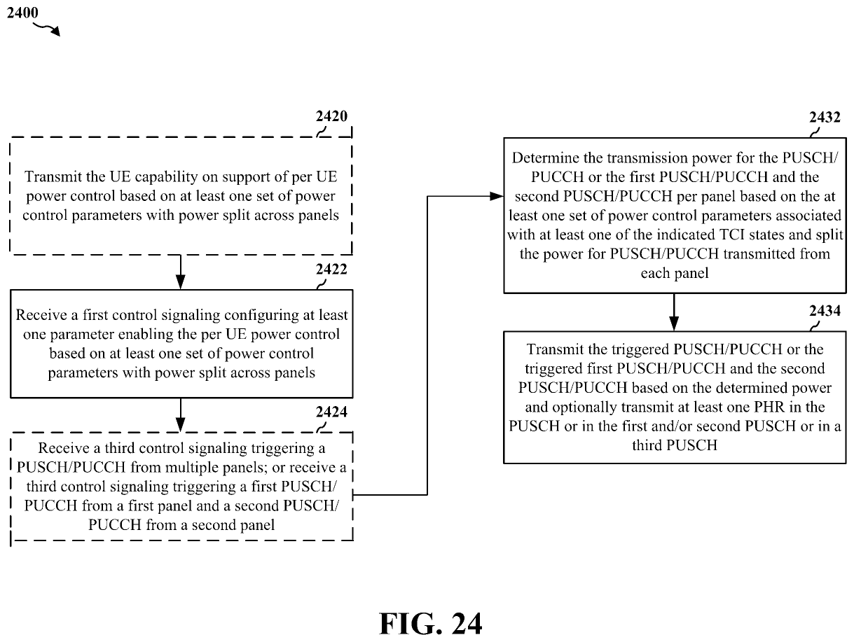

FIG. 24 is a flowchart of a method 2400 of wireless communications by a UE for per UE power control with power split per panel, corresponding to the signaling diagrams 2200 and 2300 in FIGS. 22 and 23. As shown, the UE optionally transmits 2420 the UE capability on support of per UE power control based on at least one set of power control parameters with power split across panels. The UE receives 2422 a first control signaling configuring at least one parameter enabling the per UE power control based on at least one set of power control parameters with power split across panels.

In an embodiment regarding the UE capability for power split per panel, the UE transmits 2420 a UE capability indicating at least one of the elements: whether the UE supports per-UE power control with power split for each panel; the supported power split scheme(s), e.g., equal split, scaling factor based split and so on; the maximum transmission power for each panel. The UE may report the UE capability per feature set, per band, per band combination, or per UE.

The UE optionally receives 2424 a third control signaling triggering a PUSCH/PUCCH from multiple panels; or receive a third control signaling triggering a first PUSCH/PUCCH from a first panel and a second PUSCH/PUCCH from a second panel. The UE determines 2432 the transmission power for the PUSCH/PUCCH or the first PUSCH/PUCCH and the second PUSCH/PUCCH per panel based on the at least one set of power control parameters associated with at least one of the indicated TCI states and split the power for PUSCH/PUCCH transmitted from each panel. The UE transmits 2434 the triggered PUSCH/PUCCH or the triggered first PUSCH/PUCCH and the second PUSCH/PUCCH based on the determined power and optionally transmit at least one PHR in the PUSCH or in the first and/or second PUSCH or in a third PUSCH.

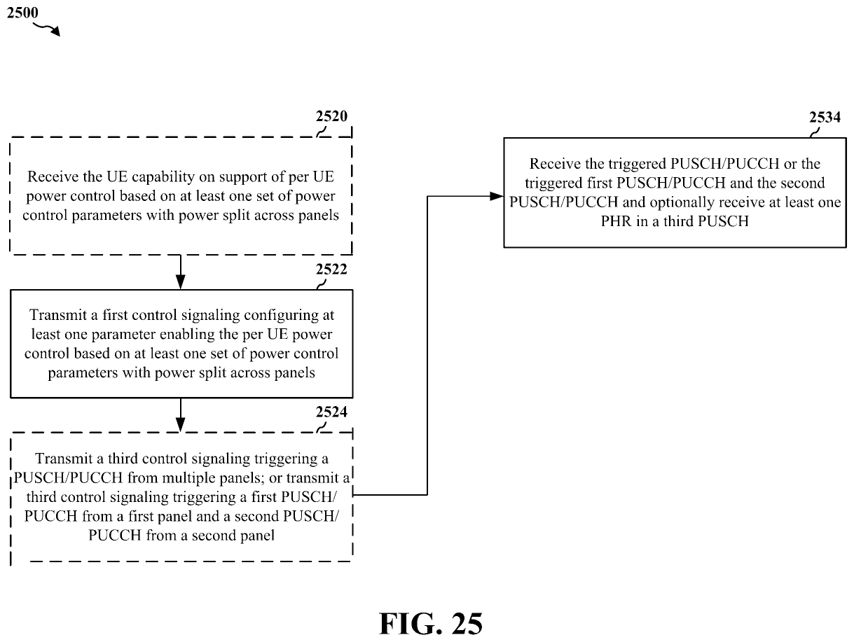

FIG. 25 is a flowchart of a method 2500 of wireless communications by a network entity for per UE power control with power split per panel, complementary to the method 2400 of FIG. 24 and corresponding to the signaling diagrams 2200 and 2300 of FIGS. 22 and 23. As shown, the network entity optionally receives 2520 the UE capability on support of per UE power control based on at least one set of power control parameters with power split across panels.

The network entity transmits 2522 a first control signaling configuring at least one parameter enabling the per UE power control based on at least one set of power control parameters with power split across panels. In an embodiment regarding the first control signaling and UE behavior for power split per panel, the network entity transmits 2522 the first control signaling configuring at least one of the parameters: a first parameter enabling or disabling the per-UE power control with power split per panel; a second parameter configuring the power split scheme, e.g., equal split, scaling factor based split and so on.

The network entity optionally transmits 2524 a third control signaling triggering a PUSCH/PUCCH from multiple panels; or transmit a third control signaling triggering a first PUSCH/PUCCH from a first panel and a second PUSCH/PUCCH from a second panel. The network entity receives 2534 the triggered PUSCH/PUCCH or the triggered first PUSCH/PUCCH and the second PUSCH/PUCCH and optionally receive at least one PHR in a third PUSCH.

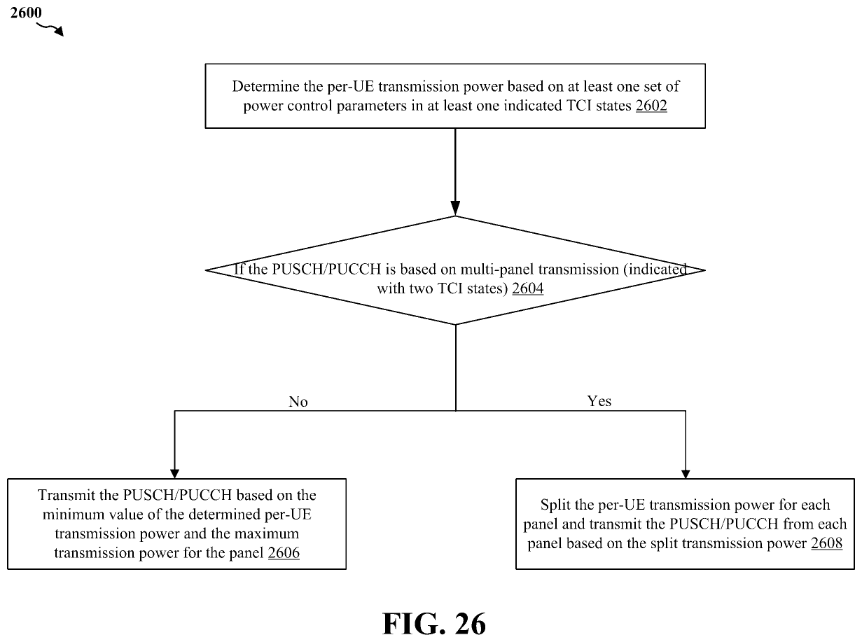

FIG. 26 is a flowchart of a method 2600 of wireless communications by a UE for the transmission power determination with power split per panel, in accordance with aspects of this disclosure. As shown, the UE firstly determines 2602 the per-UE transmission power based on at least one set of power control parameters in at least one indicated TCI states. The UE determines 2604 whether the PUSCH/PUCCH is based on multi-panel transmission (indicated with two TCI states), if so, the UE splits 2608 the per-UE transmission power for each panel and transmit the PUSCH/PUCCH from each panel based on the split transmission power. Otherwise, the UE transmits 2606 the PUSCH/PUCCH based on the minimum value of the determined per-UE transmission power and the maximum transmission power for the panel.

In an embodiment regarding per-UE transmission power based on power control parameters from one indicated TCI, the UE calculates the per-UE transmission power based on the power control parameters from one of the indicated TCI states. In some implementations, the UE determines the indicated TCI state for per-UE transmission power calculation based on a predefined rule. The UE may select the first indicated TCI state.

Alternatively, the UE may select the indicated TCI state with lower TCI identifier. Alternatively, the UE may select the indicated TCI state for the PUSCH/PUCCH that starts earlier or ends earlier. Alternatively, the UE may select the indicated TCI state for the PUSCH/PUCCH with scheduling PDCCH that starts earlier or ends earlier. Alternatively, the UE may select the indicated TCI state associated with a TRP identifier value (e.g., CORESETPoolIndex value 0, or timing advance group (TAG) ID #0).

In some implementations, the network entity configures or indicates one of the indicated TCI states for per-UE transmission power calculation by RRC signaling, MAC CE or DCI. In one example, in the DCI, the network entity indicates whether the per-UE power control may be based on the first indicated TCI states or the second TCI states.

In an embodiment regarding per-UE transmission power based on power control parameters from all indicated TCI, the UE calculates the per-UE transmission power based on a subset of or all the power control parameters from all the indicated TCI states.

In some implementations, the UE determines some power control parameters, e.g., P0, alpha and closed-loop power control index, in one of the indicated TCI states based on the same implementations of TCI state selection as in the above example implementations, and the UE determines some other power control parameters, e.g., pathloss reference signal, in all the indicated TCI states. The UE calculates the pathloss for power control based on all the configured pathloss reference signals. The UE may determine the pathloss as the maximum or minimum or average or total pathloss measured from all the pathloss reference signals.

In some implementations, the UE calculates the per-UE transmission power based on the power control parameters for all the indicated TCI states. The UE may calculate the target transmission power for each set of power control parameters for each indicated TCI states. Then the UE determines the per-UE transmission power as the maximum or minimum or average or total target transmission power calculated from each power control parameter set.

In an embodiment regarding equal power splitting per panel, the UE splits the per-UE transmission power equally for each panel for the PUSCH/PUCCH transmission. In one example, the UE determines the linear transmission power for panel j as follows:

$${P}_{Tx}^{′ ( j )} = \frac{1}{N} {P}_{Tx}^{′}$$

Where, N indicates the number of panels for the PUSCH/PUCCH transmission; P′_{Tx} indicates the determined per-UE transmission power.

In an embodiment regarding equal power splitting per port, the UE split the per-UE transmission power equally for each non-zero-power (NZP) port or configured/indicated port for the PUSCH/PUCCH transmission. In one example, the UE determines the linear transmission power for panel j as follows:

$${P}_{Tx}^{′ ( j )} = \frac{{N}_{p}^{( j )}}{{N}_{p}} {P}_{Tx}^{′}$$

Where, Np indicates the total number of non-zero-power (NZP) antenna ports or number of antenna ports for the PUSCH/PUCCH transmission;

$${N}_{p}^{( j )}$$

indicates the total number of NZP antenna ports or number of antenna ports for the PUSCH/PUCCH transmission from panel j; P′_{Tx} indicates the determined per-UE transmission power.

In an embodiment regarding power splitting based on a scaling factor, the UE splits the per-UE transmission power for each panel based on a set of scaling factors. In one example, the UE determines the linear transmission power for panel j

$${P}_{Tx}^{′ ( j )}$$

as follows:

$$\begin{matrix}{P}_{Tx}^{′ ( j )} = {α}_{j} {P}_{Tx}^{′} \\ {\sum }_{j = 1}^{N} {α}_{j} = 1\end{matrix}$$

Where, αⱼ indicates power split scaling factor for panel j; P′_{Tx} indicates the determined per-UE transmission power.

In some implementations, the UE determines the scaling factors based on the maximum transmission power per panel. In one example, the UE determines the scaling factor as follows:

$${α}_{j} = \frac{{P}_{c , max}^{′ ( j )}}{{\sum }_{j = 1}^{N} {P}_{c , max}^{′ ( j )}}$$

Where

$${P}_{c , max}^{′ ( j )}$$

indicates the linear maximum transmission power for panel j.

In some implementations, the UE determines the scaling factors based on the target transmission power per panel based on the uplink power control parameters per panel or per TCI. In one example, the UE determines the scaling factor as follows:

$${α}_{j} = \frac{{P}_{Tx , target}^{′ ( j )}}{{\sum }_{j = 1}^{N} {P}_{Tx , target}^{′ ( j )}}$$

Where

$${P}_{Tx , target}^{′ ( j )}$$

indicates the linear target transmission power for panel j.

In some implementations, the network entity may configure or indicate the scaling factors by RRC, MAC CE and/or DCI. In one example, the network entity may indicate the scaling factors by a 2-bit DCI field, where the first state or codepoint may indicate the scaling factors for PUSCH/PUCCH with the first and second indicated TCI are {0.4, 0.6}, the second state or codepoint may indicate the scaling factors for PUSCH/PUCCH with the first and second indicated TCI are {0.5, 0.5}; the third state or codepoint may indicate the scaling factors for PUSCH/PUCCH with the first and second indicated TCI are {0.6, 0.4}; the fourth state or codepoint may indicate the scaling factors for PUSCH/PUCCH with the first and second indicated TCI are {0.8, 0.2}.

In one example, the network entity may indicate the scaling factors by a 2-bit DCI field, where one of indicated state or codepoint may only indicated scaling factor for one indicated TCI state. In one example, the 2-bit DCI field may also indicate scaling factor for one panel.

Although the above implementations/embodiments mainly mention power control related to multi-panel transmission for PUCCH and PUSCH, it may be understood that the multi-panel transmission may also be SRS transmission and/or PRACH transmission. For example, one panel for PUSCH transmission, and another panel for SRS transmission. For example, one panel for PUCCH transmission, and another panel for PRACH transmission.

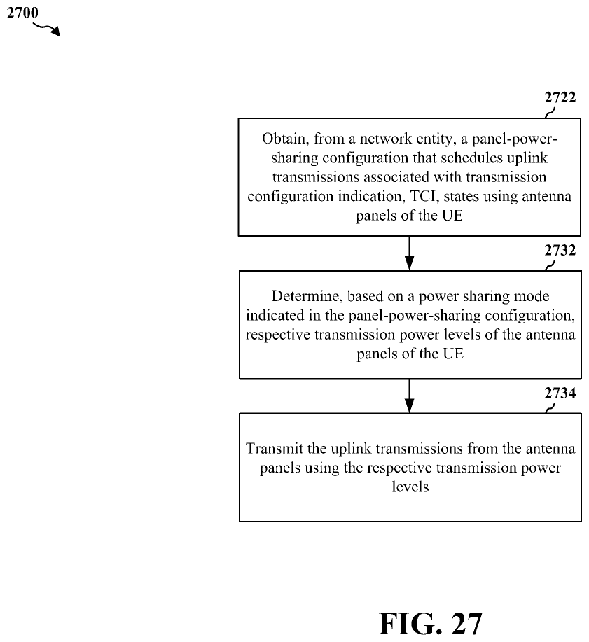

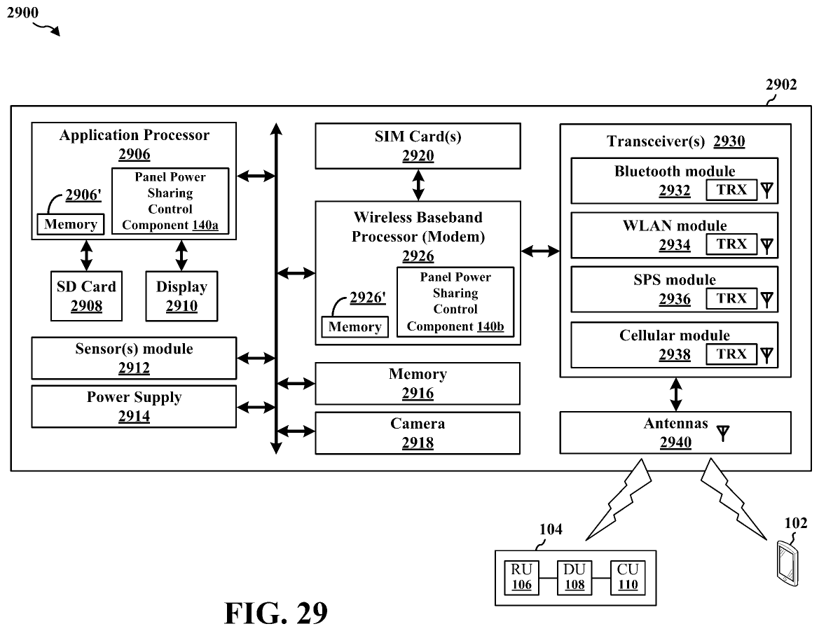

FIG. 27 illustrates a flowchart of a method 2700 of wireless communication at a UE. With reference to FIGS. 1 and 29, the method may be performed by the UE 102, the UE apparatus 2902, etc., which may include the memory 2926′, 2906′, 2916, and which may correspond to the entire UE 102 or the entire UE apparatus 2902, or a component of the UE 102 or the UE apparatus 2902, such as the wireless baseband processor 2926 and/or the application processor 2906.

In FIG. 27, the UE obtains 2722, from a network entity (e.g., the NE 104), a panel-power-sharing configuration that schedules uplink transmissions associated with transmission configuration indication, TCI, states using antenna panels of the UE.

The UE determines 2732, based on a power sharing mode indicated in the panel-power-sharing configuration, respective transmission power levels of the antenna panels of the UE.

The UE transmits 2734 transmit the uplink transmissions from the antenna panels using the respective transmission power levels.

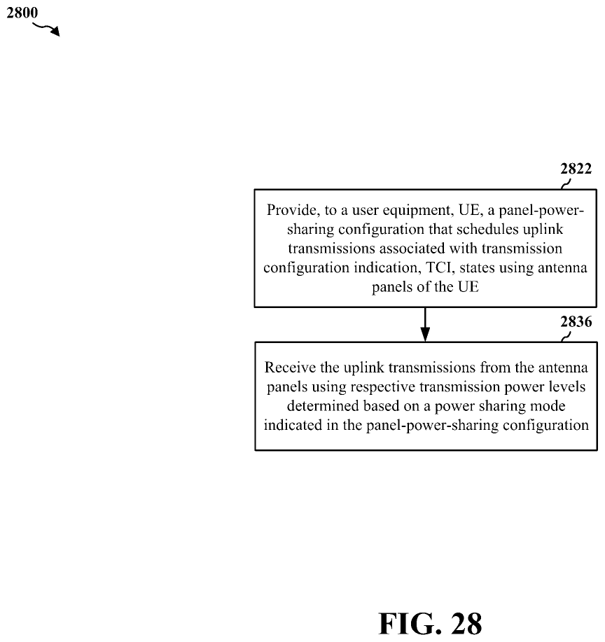

FIG. 27 describes a method 2700 from a UE-side of a wireless communication link, whereas FIG. 28 describes a method 2800 from a network-side of the wireless communication link.

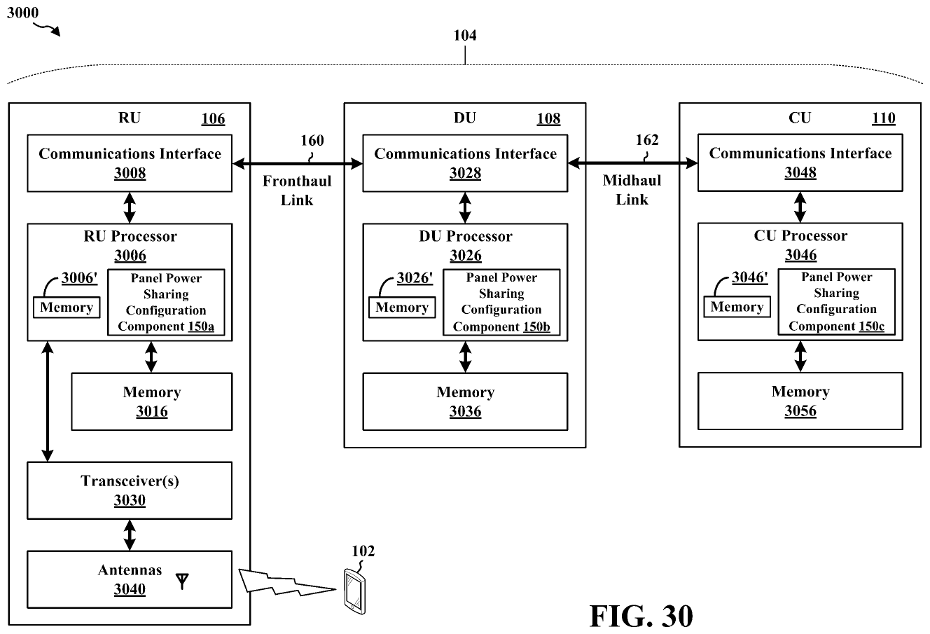

FIG. 28 illustrates the flowchart 2800 of a method of wireless communication at a network entity. With reference to FIGS. 1 and 30, the method may be performed by one or more network entities 104, which may correspond to a base station or a unit of the base station, such as the RU 106, the DU 108, the CU 110, an RU processor 3006, a DU processor 3026, a CU processor 3046, etc. The one or more network entities 104 may include memory 3006′/3026′/3046′, which may correspond to an entirety of the one or more network entities 104, or a component of the one or more network entities 104, such as the RU processor 3006, the DU processor 3026, or the CU processor 3046.

In FIG. 28, the network entity provides 2822, to a UE, a panel-power-sharing configuration that schedules uplink transmissions associated with transmission configuration indication, TCI, states using antenna panels of the UE.

The network entity receives 2836 the uplink transmissions from the antenna panels using respective transmission power levels determined based on a power sharing mode indicated in the panel-power-sharing configuration. Detailed aspects of the methods 2700 and 2800 are discussed below.

In aspects, the power sharing mode is one of a semi-static power sharing mode, a dynamic power sharing mode, or a fixed power sharing mode. For example, if the power sharing mode is the semi-static power sharing mode, the determining of the respective transmission power levels includes implementing the configuration from the network entity indicating schemes for a maximum transmission power and a power sharing scheme across the antenna panels. If the power sharing mode is the dynamic power sharing mode, the determining of the respective transmission power levels includes calculating a transmission power level for each of the antenna panels independently. If the power sharing mode is the fixed power sharing mode, the determining of the respective transmission power levels includes calculating a transmission power level for each of the antenna panels based on one or more parameters associated with the TCI states provided in the panel-power-sharing configuration.

In some cases, the power sharing mode is the semi-static power sharing mode and the method further includes receiving a control signaling from the network entity, the control signaling indicating the schemes for the maximum transmission power and the power sharing scheme. The schemes for the maximum transmission power indicate a respective power level upper limit for each of the antenna panels. The power sharing scheme indicates a power split ratio among the antenna panels. In some cases, the determining of the respective transmission power levels further includes scaling the respective transmission power levels based on a priority comparison among a first transmission to be transmitted by one of the antenna panels and a second transmission to be transmitted by another one of the antenna panels.

In some cases, the UE transmits to the network entity, a report of a panel index of one of the antenna panels for at least a group of beams associated with the TCI states, wherein the report includes at least two of the TCI states, each corresponding to one of the antenna panels, synchronization signal block resource indexes, SSBRI, or channel state information reference signal, CSI-RS, resource indexes, CRIs. In some cases, the report includes a medium access control, MAC, control element, CE, or an uplink control information, UCI.

In some cases, the UE receives an indication from the network entity regarding a panel index of one of the antenna panels associated with the panel-power-sharing configuration that schedules the uplink transmissions, wherein the indication includes an implicit indication based on an order of the TCI states or an explicit indication for each of the TCI states. In some cases, the UE transmits, to the network entity, a negative acknowledgement message when an index of the antenna panels of the UE is not aligned with the panel index in the indication received from the network entity. The UE may transmit, to the network entity, an acknowledgement message when the index of the antenna panels of the UE is aligned with the panel index in the indication received from the network entity.

In aspects, the transmitting of the uplink transmissions includes: transmitting a power headroom, PH, report that includes a maximum transmission power across the antenna panels and a power headroom calculated based on the maximum transmission power and a number of activated antenna panels or TCI states in the UE. In some cases, the PH report further includes at least one of: a single PH report with one or more panels PH calculations; multiple per-panel PH reports; a configured report of PH calculations configured by the network entity; an event based report triggered by conditions configured by the network entity; or a capability based report based on the UE's support of one or more of the above reports.

In aspects, the power sharing mode is the dynamic power sharing mode and the determining of the respective transmission power levels further includes: performing power control for each of the antenna panels independently based on one or more of: priorities associated with the uplink transmissions of each of the antenna panels; per symbol power scaling for one or more of the antenna panels; per transmission occasion power scaling for one among the antenna panels or all the antenna panels; and a capability supporting power level changes in time domain across different among the antenna panels.

In some cases, the transmitting of the uplink transmissions includes: transmitting a power headroom (PH) report that includes power headroom information for each of the antenna panels and a maximum transmission power level for each of the antenna panels or all the antenna panels. In some cases, the UE calculates the power headroom information based on the maximum transmission power level for the uplink transmissions and an actual transmission power or a reference transmission power for: (1) a first symbol of the uplink transmissions, or (2) the uplink transmissions. For example, the calculating of the power headroom information including determining a statical power headroom from each symbol of the uplink transmission and determining a statistical maximum transmission power for the uplink transmission from each symbol.

In aspects, the power sharing mode is the fixed power sharing mode and the determining of the respective transmission power levels further includes: calculating the respective transmission power levels based on one or more uplink power control parameters corresponding to an indicated one of the TCI states; or calculating the respective transmission power levels based on a subset of the one or more uplink power control parameters of all indicated ones of the TCI states. In some cases, the determining of the respective transmission power levels further includes: equally splitting power among the antenna panels; equally splitting power among antenna ports of the antenna panels; or calculating the respective power levels based on a set of scaling factors.

A UE apparatus 2902, as described in FIG. 29, may perform the method of flowchart 2700. The one or more network entities 104, as described in FIG. 30, may perform the method of flowchart 2800.

FIG. 29 is a diagram 2900 illustrating an example of a hardware implementation for a UE apparatus 2902. The UE apparatus 2902 may be the UE 102, a component of the UE 102, or may implement UE functionality. The UE apparatus 2902 may include an application processor 2906, which may have on-chip memory 2906′. In examples, the application processor 2906 may be coupled to a secure digital (SD) card 2908 and/or a display 2910. The application processor 2906 may also be coupled to a sensor(s) module 2912, a power supply 2914, an additional module of memory 2916, a camera 2918, and/or other related components. For example, the sensor(s) module 2912 may control a barometric pressure sensor/altimeter, a motion sensor such as an inertial management unit (IMU), a gyroscope, accelerometer(s), a light detection and ranging (LIDAR) device, a radio-assisted detection and ranging (RADAR) device, a sound navigation and ranging (SONAR) device, a magnetometer, an audio device, and/or other technologies used for positioning.

The UE apparatus 2902 may further include a wireless baseband processor 2926, which may be referred to as a modem. The wireless baseband processor 2926 may have on-chip memory 2926′. Along with, and similar to, the application processor 2906, the wireless baseband processor 2926 may also be coupled to the sensor(s) module 2912, the power supply 2914, the additional module of memory 2916, the camera 2918, and/or other related components. The wireless baseband processor 2926 may be additionally coupled to one or more subscriber identity module (SIM) card(s) 2920 and/or one or more transceivers 2930 (e.g., wireless RF transceivers).

Within the one or more transceivers 2930, the UE apparatus 2902 may include a Bluetooth module 2932, a WLAN module 2934, an SPS module 2936 (e.g., GNSS module), and/or a cellular module 2938. The Bluetooth module 2932, the WLAN module 2934, the SPS module 2936, and the cellular module 2938 may each include an on-chip transceiver (TRX), or in some cases, just a transmitter (TX) or just a receiver (RX). The Bluetooth module 2932, the WLAN module 2934, the SPS module 2936, and the cellular module 2938 may each include dedicated antennas and/or utilize antennas 2940 for communication with one or more other nodes. For example, the UE apparatus 2902 may communicate through the transceiver(s) 2930 via the antennas 2940 with another UE 102 (e.g., sidelink communication) and/or with a network entity 104 (e.g., uplink/downlink communication), where the network entity 104 may correspond to a base station or a unit of the base station, such as the RU 106, the DU 108, or the CU 110.

The wireless baseband processor 2926 and the application processor 2906 may each include a computer-readable medium/memory 2926′, 2906′, respectively. The additional module of memory 2916 may also be considered a computer-readable medium/memory. Each computer-readable medium/memory 2926′, 2906′, 2916 may be non-transitory. The wireless baseband processor 2926 and the application processor 2906 may each be responsible for general processing, including execution of software stored on the computer-readable medium/memory 2926′, 2906′, 2916. The software, when executed by the wireless baseband processor 2926/application processor 2906, causes the wireless baseband processor 2926/application processor 2906 to perform the various functions described herein. The computer-readable medium/memory may also be used for storing data that is manipulated by the wireless baseband processor 2926/application processor 2906 when executing the software. The wireless baseband processor 2926/application processor 2906 may be a component of the UE 102. The UE apparatus 2902 may be a processor chip (e.g., modem and/or application) and include just the wireless baseband processor 2926 and/or the application processor 2906. In other examples, the UE apparatus 2902 may be the entire UE 102 and include the additional modules of the apparatus 2902.

As discussed, the panel power sharing control component 140 is configured to obtain, from a network entity, a panel-power-sharing configuration that schedules uplink transmissions associated with transmission configuration indication, TCI, states using antenna panels of the UE. The panel power sharing control component 140 may further determine, based on a power sharing mode indicated in the panel-power-sharing configuration, respective transmission power levels of the antenna panels of the UE. The power sharing control component 140 then transmits (or causes the UE 102 to transmit) the uplink transmissions from the antenna panels using the respective transmission power levels.

The panel power sharing control component 140 may be within the application processor 2906 (e.g., at 140a), the wireless baseband processor 2926 (e.g., at 140b), or both the application processor 2906 and the wireless baseband processor 2926. The panel power sharing control component 140a-140b may be one or more hardware components specifically configured to carry out the stated processes/algorithm, implemented by one or more processors configured to perform the stated processes/algorithm, stored within a computer-readable medium for implementation by the one or more processors, or a combination thereof.

FIG. 30 is a diagram 3000 illustrating an example of a hardware implementation for one or more network entities 104. The one or more network entities 104 may be a base station, a component of a base station, or may implement base station functionality. The one or more network entities 104 may include, or may correspond to, at least one of the RU 106, the DU, 108, or the CU 110. The CU 110 may include a CU processor 3046, which may have on-chip memory 3046′. In some aspects, the CU 110 may further include an additional module of memory 3056 and/or a communications interface 3048, both of which may be coupled to the CU processor 3046. The CU 110 may communicate with the DU 108 through a midhaul link 162, such as an F1 interface between the communications interface 3048 of the CU 110 and a communications interface 3028 of the DU 108.

The DU 108 may include a DU processor 3026, which may have on-chip memory 3026′. In some aspects, the DU 108 may further include an additional module of memory 3036 and/or the communications interface 3028, both of which may be coupled to the DU processor 3026. The DU 108 may communicate with the RU 106 through a fronthaul link 160 between the communications interface 3028 of the DU 108 and a communications interface 3008 of the RU 106.

The RU 106 may include an RU processor 3006, which may have on-chip memory 3006′. In some aspects, the RU 106 may further include an additional module of memory 3016, the communications interface 3008, and one or more transceivers 3030, all of which may be coupled to the RU processor 3006. The RU 106 may further include antennas 3040, which may be coupled to the one or more transceivers 3030, such that the RU 106 may communicate through the one or more transceivers 3030 via the antennas 3040 with the UE 102.

The on-chip memory 3006′, 3026′, 3046′ and the additional modules of memory 3016, 3036, 3056 may each be considered a computer-readable medium/memory. Each computer-readable medium/memory may be non-transitory. Each of the processors 3006, 3026, 3046 is responsible for general processing, including execution of software stored on the computer-readable medium/memory. The software, when executed by the corresponding processor(s) 3006, 3026, 3046 causes the processor(s) 3006, 3026, 3046 to perform the various functions described herein. The computer-readable medium/memory may also be used for storing data that is manipulated by the processor(s) 3006, 3026, 3046 when executing the software. In examples, the panel power sharing configuration component 150 may sit at any of the one or more network entities 104, such as at the CU 110; both the CU 110 and the DU 108; each of the CU 110, the DU 108, and the RU 106; the DU 108; both the DU 108 and the RU 106; or the RU 106.

As discussed, the panel power sharing configuration component 150 is configured to provide, to a UE, a panel-power-sharing configuration that schedules uplink transmissions associated with transmission configuration indication, TCI, states using antenna panels of the UE. The panel power sharing configuration component 150 then receives (or causes the network entity 104 to receive) the uplink transmissions from the antenna panels using respective transmission power levels determined based on a power sharing mode indicated in the panel-power-sharing configuration.

The panel power sharing configuration component 150 may be within one or more processors of the one or more network entities 104, such as the RU processor 3006 (e.g., at 150a), the DU processor 3026 (e.g., at 150b), and/or the CU processor 3046 (e.g., at 150c). The panel power sharing configuration component 150a-150c may be one or more hardware components specifically configured to carry out the stated processes/algorithm, implemented by one or more processors 3006, 3026, 3046 configured to perform the stated processes/algorithm, stored within a computer-readable medium for implementation by the one or more processors 3006, 3026, 3046, or a combination thereof.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate implementational elements of the diagrams. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and may include a random-access memory (RAM), a read-only memory (ROM), an electrically erasable programmable ROM (EEPROM), optical disk storage, magnetic disk storage, other magnetic storage devices, combinations of these types of computer-readable media, or any other medium that may be used to store computer executable code in the form of instructions or data structures that may be accessed by a computer. Storage media may be any available media that may be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The terms “may”, “might”, and “may”, as used in this disclosure, often carry certain connotations. For example, “may” refers to a permissible feature that may or may not occur, “might” refers to a feature that probably occurs, and “may” refers to a capability (e.g., capable of). The phrase “For example” often carries a similar connotation to “may” and, therefore, “may” is sometimes excluded from sentences that include “for example” or other similar phrases.

Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets may be interpreted as a set of elements where the elements number one or more.

Unless otherwise specifically indicated, ordinal terms such as “first” and “second” do not necessarily imply an order in time, sequence, numerical value, etc., but are used to distinguish between different instances of a term or phrase that follows each ordinal term. Reference numbers, as used in the specification and figures, are sometimes cross-referenced among drawings to denote same or similar features. A feature that is exactly the same in multiple drawings may be labeled with the same reference number in the multiple drawings. A feature that is similar among the multiple drawings, but not exactly the same, may be labeled with reference numbers that have different leading numbers, but have one or more of the same trailing numbers (e.g., 206, 306, 406, etc., may refer to similar features in the drawings). Sometimes an “X” is used to universally denote multiple variations of a feature. For instance, “X06” may universally refer to all reference numbers that end in “06” (e.g., 206, 306, 406, etc.).

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

### EXAMPLES

Example 1. A method for wireless communications by a user equipment (102), UE, the method comprising:
obtaining, from a network entity (104), a panel-power-sharing configuration for uplink transmissions associated with transmission configuration indication, TCI, states using antenna panels of the UE; determining, based on a power sharing mode indicated in the panel-power-sharing configuration, respective transmission power levels of the antenna panels of the UE; and
transmitting the uplink transmissions from the antenna panels using the respective transmission power levels. The panel-power-sharing configuration refers to one or more panels and can be conveyed via one or more DCIs, an RRC configuration or other control messages. The panel-power-sharing configuration here covers scheduling and power sharing parameters, which may be conveyed in plural control messages.

Example 2. The method of Example 1, wherein the UE transmits the uplink transmissions on a physical uplink control channel, PUCCH, or a physical uplink shared channel, PUSCH, from each of the antenna panels at the respective transmission power levels.

Example 3. The method of Example 1 or 2, wherein the power sharing mode is one of a semi-static power sharing mode, a dynamic power sharing mode, or a fixed power sharing mode, wherein:
if the power sharing mode is the semi-static power sharing mode, the determining of the respective transmission power levels comprises implementing the configuration from the network entity indicating schemes for a maximum transmission power and a power sharing scheme across the antenna panels;
if the power sharing mode is the dynamic power sharing mode, the determining of the respective transmission power levels comprises calculating a transmission power level for each of the antenna panels independently; and
if the power sharing mode is the fixed power sharing mode, the determining of the respective transmission power levels comprises calculating a transmission power level for each of the antenna panels based on one or more parameters associated with the TCI states provided in the panel-power-sharing configuration.

Example 4. The method of Example 3, wherein the power sharing mode is the semi-static power sharing mode and the method further comprises:
receiving (522) a control signaling from the network entity, the control signaling indicating the schemes for the maximum transmission power and the power sharing scheme, wherein:
   the schemes for the maximum transmission power indicate a respective power level upper limit for each of the antenna panels, and
   the power sharing scheme indicates a power split ratio among the antenna panels.

Example 5. The method of Example 4, wherein the determining of the respective transmission power levels further comprises:
scaling the respective transmission power levels based on a priority comparison among a first transmission to be transmitted by one of the antenna panels and a second transmission to be transmitted by another one of the antenna panels.

Example 6. The method of Example 5, further comprising:
transmitting, to the network entity, a report of a panel index of one of the antenna panels for at least a group of beams associated with the TCI states, wherein the report comprises at least two of the TCI states, each corresponding to one of the antenna panels, synchronization signal block resource indexes, SSBRI, or channel state information reference signal, CSI-RS, resource indexes, CRIs.

Example 7. The method of Example 6, wherein the report comprises a medium access control, MAC, control element, CE, or an uplink control information, UCI.

Example 8. The method of Example 5, further comprising:
receiving an indication from the network entity regarding a panel index of one of the antenna panels associated with the panel-power-sharing configuration that schedules the uplink transmissions, wherein the indication includes an implicit indication based on an order of the TCI states or an explicit indication for each of the TCI states.

Example 9. The method of Example 8, further comprising:
transmitting, to the network entity, a negative acknowledgement message when an index of the antenna panels of the UE is not aligned with the panel index in the indication received from the network entity; or
transmitting, to the network entity, an acknowledgement message when the index of the antenna panels of the UE is aligned with the panel index in the indication received from the network entity.

Example 10. The method of Example 8 or 9, wherein the UE receives of the indication via:
a radio resource control, RRC, message;
a media access control, MAC, control element, CE; or
a downlink control information, DCI.

Example 11. The method of any of claims 3 to 10, wherein the transmitting of the uplink transmissions comprises:
transmitting a power headroom, PH, report that includes a maximum transmission power across the antenna panels and a power headroom calculated based on the maximum transmission power and a number of activated antenna panels or TCI states in the UE.

Example 12. The method of Example 11, wherein the PH report further comprises at least one of:
a single PH report with one or more panels PH calculations;
multiple per-panel PH reports;
a configured report of PH calculations configured by the network entity;
an event based report triggered by conditions configured by the network entity; or
a capability based report based on the UE's support of one or more of the above reports.

Example 13. The method of Example 3, wherein the power sharing mode is the dynamic power sharing mode and the determining of the respective transmission power levels further comprises:
performing power control for each of the antenna panels independently based on one or more of:
   priorities associated with the uplink transmissions of each of the antenna panels;
   per symbol power scaling for one or more of the antenna panels;
   per transmission occasion power scaling for one among the antenna panels or all the antenna panels; and
   a capability supporting power level changes in time domain across different among the antenna panels.

Example 14. The method of Example 13, wherein the transmitting of the uplink transmissions comprises:
transmitting a power headroom (PH) report that includes power headroom information for each of the antenna panels and a maximum transmission power level for each of the antenna panels or all the antenna panels.

Example 15. The method of Example 14, further comprising:
calculating the power headroom information based on the maximum transmission power level for the uplink transmissions and an actual transmission power or a reference transmission power for:
   (1) a first symbol of the uplink transmissions, or
   (2) the uplink transmissions, wherein the calculating of the power headroom information including determining a statical power headroom from each symbol of the uplink transmission and determining a statistical maximum transmission power for the uplink transmission from each symbol.

Example 16. The method of Example 3, wherein the power sharing mode is the fixed power sharing mode and the determining of the respective transmission power levels further comprises:
calculating the respective transmission power levels based on one or more uplink power control parameters corresponding to an indicated one of the TCI states; or
calculating the respective transmission power levels based on a subset of the one or more uplink power control parameters of all indicated ones of the TCI states.

Example 17. The method of Example 16, wherein the determining of the respective transmission power levels further comprises:
equally splitting power among the antenna panels;
equally splitting power among antenna ports of the antenna panels; or
   calculating the respective power levels based on a set of scaling factors.

Example 18. A method for wireless communications by a network entity, the method comprising:
providing, to a user equipment, UE, a panel-power-sharing configuration that schedules uplink transmissions associated with transmission configuration indication, TCI, states using antenna panels of the UE; and
receiving the uplink transmissions from the antenna panels using respective transmission power levels determined based on a power sharing mode indicated in the panel-power-sharing configuration.

Example 19. The method of Example 18, wherein the power sharing mode is one of a semi-static power sharing mode, a dynamic power sharing mode, or a fixed power sharing mode, wherein:
if the power sharing mode is the semi-static power sharing mode, the respective transmission power levels are determined by implementing the configuration from the network entity indicating schemes for a maximum transmission power and a power sharing scheme across the antenna panels;
if the power sharing mode is the dynamic power sharing mode, the respective transmission power levels are determined by calculating a transmission power level for each of the antenna panels independently; and
if the power sharing mode is the fixed power sharing mode, the respective transmission power levels are determined by calculating a transmission power level for each of the antenna panels based on one or more parameters associated with the TCI states provided in the panel-power-sharing configuration.

Example 20. The method of Example 19, wherein the power sharing mode is the semi-static power sharing mode and the method further comprises:
transmitting (522) a control signaling to the UE, the control signaling indicating the schemes for the maximum transmission power and the power sharing scheme, wherein:
   the schemes for the maximum transmission power indicate a respective power level upper limit for each of the antenna panels, and
   the power sharing scheme indicates a power split ratio among the antenna panels.

Example 21. The method of Example 20, wherein the respective transmission power levels are determined by:
scaling the respective transmission power levels based on a priority comparison among a first transmission to be transmitted by one of the antenna panels and a second transmission to be transmitted by another one of the antenna panels.

Example 22. The method of Example 21, further comprising:
receiving, from the UE, a report of a panel index of one of the antenna panels for at least a group of beams associated with the TCI states, wherein the report comprises at least two of the TCI states, each corresponding to one of the antenna panels, synchronization signal block resource indexes, SSBRI, or channel state information reference signal, CSI-RS, resource indexes, CRIs.

Example 23. The method of Example 22, wherein the report comprises a medium access control, MAC, control element, CE, or an uplink control information, UCI.

Example 24. The method of Example 21, further comprising:
transmitting an indication to the UE regarding a panel index of one of the antenna panels associated with the panel-power-sharing configuration that schedules the uplink transmissions, wherein the indication includes an implicit indication based on an order of the TCI states or an explicit indication for each of the TCI states.

Example 25. The method of Example 24, further comprising:
receiving, from the UE, a negative acknowledgement message when an index of the antenna panels of the UE is not aligned with the panel index in the indication received from the network entity; or
receiving, from the UE, an acknowledgement message when the index of the antenna panels of the UE is aligned with the panel index in the indication received from the network entity.

Example 26. The method of Example 24 or 25, wherein the network entity transmits the indication via:
a radio resource control, RRC, message;
a media access control, MAC, control element, CE; or
a downlink control information, DCI.

Example 27. The method of any of claims 19 to 26, wherein the receiving of the uplink transmissions comprises:
receiving a power headroom, PH, report that includes a maximum transmission power across the antenna panels and a power headroom calculated based on the maximum transmission power and a number of activated antenna panels or TCI states in the UE.

Example 28. The method of Example 27, wherein the PH report further comprises at least one of:
a single PH report with one or more panels PH calculations;
multiple per-panel PH reports;
a configured report of PH calculations configured by the network entity;
an event based report triggered by conditions configured by the network entity; or
a capability based report based on the UE's support of one or more of the above reports.

Example 29. The method of Example 19, wherein the power sharing mode is the dynamic power sharing mode and the respective transmission power levels are determined by:
performing power control for each of the antenna panels independently based on one or more of:
   priorities associated with the uplink transmissions of each of the antenna panels;
   per symbol power scaling for one or more of the antenna panels;
   per transmission occasion power scaling for one among the antenna panels or all the antenna panels; and
   a capability supporting power level changes in time domain across different among the antenna panels.

Example 30. The method of Example 29, wherein the receiving of the uplink transmissions comprises:
receiving a power headroom (PH) report that includes power headroom information for each of the antenna panels and a maximum transmission power level for each of the antenna panels or all the antenna panels.

Example 31. A wireless communication device comprising a communication interface, and signal processing hardware connected to the communication interface, configured to cooperatively perform any of the methods of Examples 1 to 30.

Example 32. An apparatus, comprising a processer configured to cause a User Equipment (UE) to:
receive at least one control signaling configuring the UE to transmit the physical uplink control channel (PUCCH) or physical uplink shared channel (PUSCH) with more than one indicated transmission configuration indication (TCI) states corresponding to different UE panels and the power sharing scheme for the PUSCH/PUCCH transmitted from the more than one indicated TCI;
transmit one PUSCH/PUCCH from multiple panels or a first PUSCH/PUCCH from a first panel and a second PUSCH/PUCCH from a second panel based on configured power sharing scheme.

Example 33. The apparatus according to Example 32, wherein the UE transmits the UE capability indicating at least one of the elements: whether the UE supports semi-static power sharing for signals from different TCI states; the maximum transmission power for each panel; whether the UE supports dynamic power sharing for signals from different TCI states; whether the UE supports per-symbol power scaling or per-transmission-occasion power scaling; whether the UE supports per-UE power control with per-panel power split; the supported per-panel power split scheme(s).

Example 34. The apparatus according to Example 32, wherein the UE transmits the UE panel status report for at least a group of synchronization signal blocks (SSBs) or channel state information reference signals (CSI-RSs).

Example 35. The apparatus according to Example 34, wherein the UE transmits the UE panel status report by MAC control element (CE) or uplink control information (UCI) in PUCCH or PUSCH.

Example 36. The apparatus according to Example 32, wherein the UE receives at least one TCI states with UE panel indication.

Example 37. The apparatus according to Example 36, wherein the UE applies a first TCI switching delay if the indicated UE panel is the same as the UE panel reported for the SSB or CSI-RS that share the same quasi-co-location (QCL) property as the source reference signal in the indicated TCI; the UE applies a second TCI switching delay, otherwise.

Example 38. The apparatus according to Example 32, wherein the UE receives a control signaling indicating the maximum transmission power for each panel.

Example 39. The apparatus according to Example 38, wherein the determines the transmission power for PUSCH/PUCCH from a panel based on the received maximum transmission power for the panel and the power control parameters for the panel.

Example 40. The apparatus according to Example 32, wherein the UE transmits at least one power headroom report (PHR) in the PUSCH from multiple panels or the first PUSCH and/or the second PUSCH or a third PUSCH in another serving cell.

Example 41. The apparatus according to Example 40, wherein the UE transmits the power headroom (PH) measured from a UE panel corresponding to one indicated TCI state and the maximum transmission power for the UE panel.

Example 42. The apparatus according to Example 40, wherein the UE transmits the maximum or minimum or average power headroom (PH) measured from all the UE panels corresponding to all the indicated TCI states and the maximum or minimum or average transmission power for all the UE panels.

Example 43. The apparatus according to Example 40, wherein the UE transmits the power headroom (PH) measured from all the UE panels corresponding to all the indicated TCI states and the maximum transmission power across UE panels.

Example 44. The apparatus according to Example 40, wherein the UE transmits a UE capability indicating whether it supports single PHR report or multiple PHR reports.

Example 45. The apparatus according to Example 40, wherein the UE receives a control signaling indicating whether the UE reports a single PHR or multiple PHRs.

Example 46. The apparatus according to Example 40, wherein the UE receives a control signaling configuring at least one of the parameters in a PHR configuration for each panel.

Example 47. The apparatus according to Example 40-46, wherein the UE calculates the PH based on the maximum transmission power and the actual or reference transmission power in first symbol of a transmission occasion.

Example 48. The apparatus according to Example 40-46, wherein the UE calculates the PH as the minimum or maximum or average PH based on the maximum transmission power and the actual or reference transmission power in every symbol of a transmission occasion.

Example 49. The apparatus according to Example 32, wherein the UE transmits the PUSCH/PUCCH from multiple panels or the first and the second PUSCH with per-symbol power scaling if the total transmission power across panels exceeds the maximum transmission power per UE.

Example 50. The apparatus according to Example 32, wherein the UE transmits the PUSCH/PUCCH from multiple panels or the first and the second PUSCH with per-transmission occasion power scaling if the total transmission power across panels exceeds the maximum transmission power per UE.

Example 51. The apparatus according to Example 49-50, wherein the UE performs the power scaling for PUSCH/PUCCH from one panel.

Example 52. The apparatus according to Example 49-50, wherein the UE performs the power scaling for PUSCH/PUCCH from all the panels.

Example 53. The apparatus according to Example 49-50, wherein the UE performs per-transmission-occasion power scaling if the UE receives the scheduling PDCCH for the second PUSCH before the minimum preparation delay for the first PUSCH before the first symbol of the first PUSCH.

Example 54. The apparatus according to Example 49-50, wherein the UE performs per-symbol power scaling if the UE receives the scheduling PDCCH for the second PUSCH before the minimum preparation delay for the first PUSCH before the first symbol of the first PUSCH.

Example 55. The apparatus according to Example 32, wherein the UE calculates the per-UE transmission power across panels based on the power control parameters in one of the indicated TCI states.

Example 56. The apparatus according to Example 32, wherein the UE calculates the per-UE transmission power across panels based on a subset of or all the power control parameters in all the indicated TCI states.

Example 57. The apparatus according to Example 55-56, wherein the UE splits the linear per-UE transmission power equally for PUSCH/PUCCH from each panel.

Example 58. The apparatus according to Example 55-56, wherein the UE splits the linear per-UE transmission power equally for PUSCH/PUCCH from each port.

Example 59. The apparatus according to Example 55-56, wherein the UE splits the linear per-UE transmission power equally for PUSCH/PUCCH from non-zero-power port.

Example 60. The apparatus according to Example 55-56, wherein the UE receives a control signaling indicating a set of power slitting factors for each panel.

Example 61. The apparatus according to Example 60, wherein the UE splits the linear per-UE transmission power for PUSCH/PUCCH from each panel based on the power splitting factors.

Example 62. An apparatus, comprising a processer configured to cause a Base Station (BS) to:
transmit at least one control signaling configuring the UE to transmit the physical uplink control channel (PUCCH) or physical uplink shared channel (PUSCH) with more than one indicated transmission configuration indication (TCI) states corresponding to different UE panels and the power sharing scheme for the PUSCH/PUCCH transmitted from the more than one indicated TCI;
receive one PUSCH/PUCCH from multiple panels or a first PUSCH/PUCCH from a first panel and a second PUSCH/PUCCH from a second panel based on configured power sharing scheme.

Example 63. The apparatus according to Example 62, wherein the BS receives the UE capability indicating at least one of the elements: whether the UE supports semi-static power sharing for signals from different TCI states; the maximum transmission power for each panel; whether the UE supports dynamic power sharing for signals from different TCI states; whether the UE supports per-symbol power scaling or per-transmission-occasion power scaling; whether the UE supports per-UE power control with per-panel power split; the supported per-panel power split scheme(s).

Example 64. The apparatus according to Example 62, wherein the BS receives the UE panel status report for at least a group of synchronization signal blocks (SSBs) or channel state information reference signals (CSI-RSs).

Example 65. The apparatus according to Example 64, wherein the BS receives the UE panel status report by MAC control element (CE) or uplink control information (UCI) in PUCCH or PUSCH.

Example 66. The apparatus according to Example 62, wherein the BS transmits at least one TCI states with UE panel indication.

Example 67. The apparatus according to Example 66, wherein the BS applies a first TCI switching delay if the indicated UE panel is the same as the UE panel reported for the SSB or CSI-RS that share the same quasi-co-location (QCL) property as the source reference signal in the indicated TCI; the BS applies a second TCI switching delay, otherwise.

Example 68. The apparatus according to Example 62, wherein the BS transmits a control signaling indicating the maximum transmission power for each panel.

Example 69. The apparatus according to Example 62, wherein the BS receives at least one power headroom report (PHR) in the PUSCH from multiple panels or the first PUSCH and/or the second PUSCH or a third PUSCH in another serving cell.

Example 70. The apparatus according to Example 69, wherein the BS receives the power headroom (PH) measured from a UE panel corresponding to one indicated TCI state and the maximum transmission power for the UE panel.

Example 71. The apparatus according to Example 69, wherein the BS receives the maximum or minimum or average power headroom (PH) measured from all the UE panels corresponding to all the indicated TCI states and the maximum or minimum or average transmission power for all the UE panels.

Example 72. The apparatus according to Example 69, wherein the BS receives the power headroom (PH) measured from all the UE panels corresponding to all the indicated TCI states and the maximum transmission power across UE panels.

Example 73. The apparatus according to Example 69, wherein the BS receives a UE capability indicating whether it supports single PHR report or multiple PHR reports.

Example 74. The apparatus according to Example 69, wherein the BS transmits a control signaling indicating whether the UE reports a single PHR or multiple PHRs.

Example 75. The apparatus according to Example 69, wherein the BS transmits a control signaling configuring at least one of the parameters in a PHR configuration for each panel.

Example 76. The apparatus according to Example 62, wherein the BS receives the PUSCH/PUCCH from multiple panels or the first and the second PUSCH with per-symbol power scaling if the total transmission power across panels exceeds the maximum transmission power per UE.

Example 77. The apparatus according to Example 62, wherein the BS receives the PUSCH/PUCCH from multiple panels or the first and the second PUSCH with per-transmission occasion power scaling if the total transmission power across panels exceeds the maximum transmission power per UE.

Example 78 is a non-transitory computer-readable medium storing computer executable code, the code when executed by a processor causes the processor to implement a method as in any of examples 1-77.

What is claimed is:

1-18. (canceled)

19. A method of wireless communication by a user equipment (UE), the method comprising:
receiving, from a network entity, a configuration for uplink power control for a multiple panel uplink transmission associated with transmission configuration indication (TCI) states;
determining, based on the configuration, a transmission power for an indicated TCI state of the TCI states associated with the multiple panel uplink transmission, the transmission power being based on a maximum transmission power per panel and power control parameters associated with the indicated TCI state; and
transmitting, to the network entity, the multiple panel uplink transmission using the transmission power for the indicated TCI state.

20. The method of claim 19, wherein the multiple panel uplink transmission is associated with a power sharing mode being one of a semi-static power sharing mode, a dynamic power sharing mode, or a fixed power sharing mode, wherein:
if the power sharing mode is the semi-static power sharing mode, determining the transmission power comprises implementing the configuration from the network entity indicating schemes for the maximum transmission power and a power sharing scheme across antenna panels of the UE;
if the power sharing mode is the dynamic power sharing mode, determining the transmission power comprises calculating a transmission power level for each of the antenna panels independently; and
if the power sharing mode is the fixed power sharing mode, determining the transmission power comprises calculating a transmission power level for each of the antenna panels based on one or more parameters associated with the TCI states provided in the configuration.

21. The method of claim 20, wherein the power sharing mode is the semi-static power sharing mode and the method further comprises:
receiving a control signaling from the network entity, the control signaling indicating the schemes for the maximum transmission power and the power sharing scheme, wherein:
the schemes for the maximum transmission power indicate a respective power level upper limit for each of the antenna panels, and
the power sharing scheme indicates a power split ratio among the antenna panels.

22. The method of claim 21, wherein determining the transmission power further comprises:
scaling the respective transmission power levels based on a priority comparison among a first transmission to be transmitted by one of the antenna panels and a second transmission to be transmitted by another one of the antenna panels.

23. The method of claim 22, further comprising:
transmitting, to the network entity, a report of a panel index of one of the antenna panels for at least a group of beams associated with the TCI states, wherein the report comprises at least two of the TCI states, each corresponding to one of the antenna panels, synchronization signal block resource indexes, SSBRI, or channel state information reference signal, CSI-RS, resource indexes, CRIs.

24. The method of claim 23, wherein the report comprises a medium access control, MAC, control element, CE, or an uplink control information, UCI.

25. The method of claim 22, further comprising:
receiving an indication from the network entity regarding a panel index of one of the antenna panels associated with the configuration that schedules the multiple panel uplink transmission, based on an order of the TCI states or another explicitly specified order of the TCI states.

26. The method of claim 25, further comprising:
transmitting, to the network entity, a negative acknowledgement message when an index of the antenna panels of the UE is not aligned with the panel index in the indication received from the network entity; or
transmitting, to the network entity, an acknowledgement message when the index of the antenna panels of the UE is aligned with the panel index in the indication received from the network entity.

27. The method of claim 20, wherein the transmitting of the multiple panel uplink transmission comprises:
transmitting a power headroom, PH, report that includes a maximum transmission power across the antenna panels and a power headroom calculated based on the maximum transmission power and a number of activated antenna panels or TCI states in the UE.

28. The method of claim 27, wherein the PH report further comprises at least one of:
a single PH report with one or more panels PH calculations;
multiple per-panel PH reports;
a configured report of PH calculations configured by the network entity;
an event based report triggered by conditions configured by the network entity; or
a capability based report based on the UE's support of one or more of the above reports.

29. The method of claim 20, wherein the power sharing mode is the dynamic power sharing mode and determining the transmission power further comprises:
performing power control for each of the antenna panels independently based on one or more of:
priorities associated with an uplink transmission of each of the antenna panels;
per symbol power scaling for one or more of the antenna panels;
per transmission occasion power scaling for one among the antenna panels or all the antenna panels; and
a capability supporting power level changes in time domain across different among the antenna panels.

30. The method of claim 29, wherein the transmitting of the multiple panel uplink transmission comprises:
transmitting a power headroom, PH, report that includes power headroom information for each of the antenna panels and a maximum transmission power level for each of the antenna panels or all the antenna panels.

31. The method of claim 30, further comprising:
calculating the power headroom information based on the maximum transmission power level for the uplink transmission and an actual transmission power or a reference transmission power for:
a first symbol of the uplink transmission, or
the uplink transmission, wherein the calculating of the power headroom information including determining a statical power headroom from each symbol of the uplink transmission and determining a statistical maximum transmission power for the uplink transmission from each symbol.

32. The method of claim 20, wherein the power sharing mode is the fixed power sharing mode and determining the transmission power further comprises:
calculating respective transmission power levels for each antenna panel based on one or more uplink power control parameters corresponding to a corresponding indicated TCI states of the TCI states; or
calculating the respective transmission power levels based on a subset of the one or more uplink power control parameters of one or more corresponding indicated TCI states of the TCI states.

33. The method of claim 32, wherein determining the transmission power further comprises:
equally splitting power among the antenna panels;
equally splitting power among antenna ports of the antenna panels; or
calculating the respective power levels based on a set of scaling factors.

34. A method for wireless communications by a network entity, the method comprising:
transmitting, to a user equipment (UE), a configuration for uplink power control for a multiple panel uplink transmission associated with transmission configuration indication (TCI) states; and
receiving, from the UE, the multiple panel uplink transmission having a transmission power for an indicated TCI state of the TCI states, the transmission power being based on a maximum transmission power per panel and power control parameters associated with the indicated TCI state.

35. The method of claim 34, wherein the multiple panel uplink transmission is associated with a power sharing mode being one of a semi-static power sharing mode, a dynamic power sharing mode, or a fixed power sharing mode, wherein:
if the power sharing mode is the semi-static power sharing mode, the UE is directed to determine respective transmission power levels by implementing the configuration from the network entity indicating schemes for a maximum transmission power and a power sharing scheme across antenna panels;
if the power sharing mode is the dynamic power sharing mode, the UE is directed to determine the respective transmission power levels by calculating a transmission power level for each of the antenna panels independently; and
if the power sharing mode is the fixed power sharing mode, the UE is directed to determine the respective transmission power levels by calculating a transmission power level for each of the antenna panels based on one or more parameters associated with the TCI states provided in the configuration.

36. An apparatus for wireless communications, comprising:
one or more radio frequency (RF) modems;
a processor coupled to the one or more RF modems; and
at least one memory storing executable instructions, the executable instructions to manipulate at least one of the processor or the one or more RF modems to:
receive, from a network entity, a configuration for uplink power control for a multiple panel uplink transmission associated with transmission configuration indication, TCI, states;
determine, based on the configuration, a transmission power for an indicated TCI state of the TCI states associated with the multiple panel uplink transmission, the transmission power being based on a maximum transmission power per panel and power control parameters associated with the indicated TCI state; and
transmit, to the network entity, the multiple panel uplink transmission using the transmission power for the indicated TCI state.

37. The apparatus of claim 36, wherein the multiple panel uplink transmission is associated with a power sharing mode being one of a semi-static power sharing mode, a dynamic power sharing mode, or a fixed power sharing mode, wherein:
if the power sharing mode is the semi-static power sharing mode, determining the transmission power comprises implementing the configuration from the network entity indicating schemes for the maximum transmission power and a power sharing scheme across antenna panels of the apparatus;
if the power sharing mode is the dynamic power sharing mode, determining the transmission power comprises calculating a transmission power level for each of the antenna panels independently; and
if the power sharing mode is the fixed power sharing mode, determining the transmission power comprises calculating a transmission power level for each of the antenna panels based on one or more parameters associated with the TCI states provided in the configuration.

38. The apparatus of claim 37, wherein the power sharing mode is the semi-static power sharing mode and at least one of the processor or the one or more RF modems are further configured to:
receive a control signaling from the network entity, the control signaling indicating the schemes for the maximum transmission power and the power sharing scheme, wherein:
the schemes for the maximum transmission power indicate a respective power level upper limit for each of the antenna panels, and
the power sharing scheme indicates a power split ratio among the antenna panels.
